(19) United States
(12) Patent Application Publication
(10) Pub. No.: US 2012/0221302 A1
(43) Pub. Date: Aug. 30, 2012

(54) Method and System For Modeling Geologic Properties Using Homogenized Mixed Finite Elements

(76) Inventors: Jerome Lewandowski, Houston, TX (US); Serguei Maliassov, Spring, TX (US)

(21) Appl. No.: 13/392,038

(22) PCT Filed: Aug. 27, 2010
(86) PCT No.: PCT/US10/46980

§ 371 Date: Feb. 23, 2012

Related U.S. Application Data
(60) Provisional application No. 61/263,633, filed on Nov. 23, 2009.

(51) Int. Cl. G06F 17/11; G06F 7/60; G06F 17/16; G06G 7/48

(52) U.S. Cl. 703/2

(57) ABSTRACT

A method for hydrocarbon management of a reservoir is provided. The method includes generating a model of a reservoir comprising a plurality of homogenized mixed finite elements in an unstructured computational mesh. The unstructured computational mesh may be coarsened to form a plurality of coarser computational meshes in the model. A convection-diffusion subsurface process may be evaluated on a coarsest computation mesh. A result may be transferred from the coarsest computational mesh to a finest computational mesh, and a performance parameter for the hydrocarbon reservoir may be predicted from the model. The predicted performance parameter may be used for hydrocarbon management of the reservoir.

### CROSS-REFERENCE TO RELATED APPLICATION

This application claims the benefit of U.S. Provisional Application No. 61/263,633, filed Nov. 23, 2009, entitled Method and System for Modeling Geologic Properties Using Homogenized Mixed Finite Elements, which is incorporated by reference, in its entirety, for all purposes.

### FIELD

Exemplary embodiments of the present techniques relate to a method and system for evaluating the parameters of convection-diffusion subsurface processes within a heterogeneous formation as represented by an unstructured grid.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Modern society is greatly dependent on the use of hydrocarbons for fuels and chemical feedstocks. Hydrocarbons are generally found in subsurface rock formations that may be termed “reservoirs.” Removing hydrocarbons from the reservoirs depends on numerous physical properties of the rock formations, such as the permeability of the rock containing the hydrocarbons, the ability of the hydrocarbons to flow through the rock formations, and the proportion of hydrocarbons present, among others. Often, mathematical models are used to locate hydrocarbons and to optimize the production of the hydrocarbons. The mathematical models use numerical models of subsurface processes to predict such parameters as production rates, optimum drilling locations, hydrocarbon locations and the like.

The numerical modeling of subsurface processes such as fluid flow dynamics, heat flow and pressure distributions in porous media involves solving mathematical equations of a convection-diffusion type. In many such applications the input data, such as the permeability or the thermal conductivity, is obtained through experimental observations or inferred by using some theoretical model. This input data may be represented on a high resolution mesh, which may be termed the “fine geologic mesh.” However, for most applications, the amount of information on the fine geologic mesh exceeds the practical computational capabilities, making such simulations computationally prohibitive or intractable. As a result, most computations can only be carried out on a mesh with a lower resolution. The lower resolution mesh may be termed the “coarse computational mesh.”

The mismatch between the resolutions for the fine geologic mesh and the coarse computational mesh implies that a procedure must be devised to convert all, or part of, the original input data on the fine geologic mesh to the resolution of the coarse computational mesh. This procedure is called up-scaling.

There are many different approaches to the up-scaling procedure with varied degrees of complexity, ranging from the simpler (and often less accurate) averaging techniques to the more complicated (and computationally expensive) techniques involving multiple local problems with different sets of boundary conditions. Up-scaling methods such as these have proven to be quite successful. However, methods of up-scaling do not provide a priori estimates of numerical accuracy for the up-scaled solution that are present when complex convection-diffusion processes are investigated using coarse computational models.

Various fundamentally different multi-scale approaches for scaling data from subsurface processes have been proposed to accommodate the fine-scale description directly. As opposed to up-scaling, the multi-scale approach targets the full problem with the original resolution. The up-scaling methodology is typically based on resolving the length- and time-scales of interest by maximizing local operations. In some approaches employing mixed finite element method, the original problem is decomposed into two sub-problems. First, fine scales are solved in terms of the coarse scale using numerical Greens functions, then, a coarse scale problem is solved after incorporating the fine scale information into the coarse scale basis functions. See, e.g., T. Arbogast, S. L Btyant, Numerical subgrid upscaling for waterflood simulations, SPE 66375, and M. Peszynska, M. F. Wheeler, I. Yotov, Mortar upscaling for multiphase flow in porous media, Computational Geosciences, 2002, v. 6, No. 1, pp. 73-100. Another approach employs a finite element method to construct specific basis functions which capture the small scales. Again, localization is achieved by boundary condition assumptions for the coarse elements. See, e.g., T. Hou, X. H. Wu, A multiscale finite element method for elliptic problems in composite materials and porous media, J. Comp. Phys., 1997, v. 134, pp. 169-189; See also, e.g., J. Aarnes, S. Krogstad, K. Lie, A hierarchical multiscale method for two-phase flow based upon mixed finite elements and nonuniform coarse grids, Multiscale Modelling and Simulation, v. 5, pp. 337-363.

In recent years, a new up-scaling algorithm has been developed, which is based on variational principles that accurately and efficiently capture the effects of a multiscale medium. See, e.g., S. P. MacLachlan, J. D. Moulton, Multilevel upscaling through variational coarsening, Water Resources Research, v. 42, No. 2, W02418. All of the multi-scale techniques mentioned provide more accurate solutions to the original fine-scale problems than the standard technologies with the application of customary up-scaling. However, these multi-scale methods were developed for structured, mostly rectangular, meshes. The use of unstructured grids places specific constraints on the numerical discretizations and the up-scaling methodology. See, e.g., U.S. Pat. No. 6,826,520.

In many cases a domain of interest can be represented as a set of layers of different thickness stacked together. The geologic layers may be fractured along vertical or slanted surfaces and degenerate, creating so-called pinch-outs. Pinch-outs are defined as parts of geologic layers with zero thickness. The geometrical complexity of the subsurface environment and the accuracy requirements impose stringent constraints on numerical methods, which can be considered for solving subsurface problems. In addition, most practical problems require not only accurately determining not only the primary variables (such as pressure or temperature), but also their fluxes (rates of flow of energy, fluids, heat flow). Currently, the only two methods of discretization applicable for most of the subsurface problems are finite volume and mixed finite element methods.

U.S. Pat. No. 6,823,297 discloses a multi-scale finite-volume (MSFV) method to solve elliptic problems with a plurality of spatial scales arising from single or multi-phase flows in porous media. The major difficulty in its application is that it depends on the construction of hierarchical Voronoi meshes, which may not be possible for an arbitrary three-dimensional domain or a domain with internal geometrical features (such as faults, pinch-outs, and the like). The problem of constructing such a hierarchy is not considered in the patent and can represent a limitation of its use.

A promising numerical discretization method for up-scaling geologic data is the mixed finite element method, which is locally mass conservative, accurate in the presence of heterogeneous medium, and provides accurate approximations to both, primary unknowns and fluxes. However, the mixed finite element methods cannot be directly applied to the domains covered by unstructured polyhedral grids that are typical in subsurface applications. Accordingly, techniques for up-scaling geologic data on irregular or unstructured polyhedral grids and arbitrary three-dimensional domains would be useful.

### SUMMARY

An exemplary embodiment of the present techniques provides a method for modeling geologic properties using homogenized mixed finite elements. The method includes projecting features of a reservoir onto a horizontal plane to form a projection and creating a two-dimensional unstructured computational mesh resolving desired features in the projection. The two-dimensional unstructured computational meshes are projected onto boundary surfaces in order to define a finest computational mesh. At least one coarser computational mesh is generated, wherein the coarser computational mesh includes a plurality of computational cells. Each of the plurality of computational cells includes a plurality of finer cells. A plurality of computational faces associated with each of the plurality of computational cells is generated, wherein each of the computational faces comprises a plurality of finer faces. A first unknown is associated with each of the plurality of computational cells and a second unknown is associated with each of the plurality of computational faces. A macro-hybrid mixed finite element discretization is derived on the finest computational mesh. An iterative coarsening procedure is performed to transfer known information from the finest computational mesh to a coarsest computational mesh. Matrix equations are solved to obtain values for each of the first unknowns for each of the plurality of computational cells in the coarsest computational mesh. Matrix equations are also solved to obtain values for each of the second unknowns for each of the plurality of computational faces in the coarsest computational mesh. An iterative restoration procedure is performed to restore the values of the primary unknowns to each of the plurality of finer cells and the secondary unknowns to each of the plurality of finer faces.

Projecting the features of the reservoir may include projecting pinch-out boundaries, fault lines, or well locations into the horizontal plane. The projection may be non-orthogonal, and/or slanted.

Each of the plurality of two-dimensional unstructured hierarchical meshes may include squares, polygons, quadrilaterals, or triangles or any combinations thereof. Further, each of the plurality of computational cells may include a box, a hexagon, a prism, a tetrahedron, or a pyramid.

The first unknown may correspond to a physical property of the reservoir, such as for example fluid pressure or temperature. The second unknown may correspond to a normal component of a flux.

The finest computational mesh may approximate boundary surfaces of layers of interest. The physical properties may be defined on the finest computational mesh. The physical properties may include permeability and/or thermal conductivity. The method may include performing a homogenized mixed finite element procedure for solving diffusion equations on prismatic meshes.

Another exemplary embodiment of the present techniques provides a system for modeling geologic properties using homogenized mixed finite elements. The system may include a processor and a storage medium including a database that includes reservoir data. The system also includes a machine readable medium that stores code configured to direct the processor to project features of a reservoir onto a horizontal plane to form a projection and create a two-dimensional unstructured computational mesh resolving desired features in the projection. The code may also be configured to direct the processor to project the two-dimensional unstructured computational mesh onto boundary surfaces in order to define a finest computational mesh, and generate at least one coarser computational mesh, wherein the coarser computational mesh includes a plurality of computational cells, and each of the plurality of computational cells comprises a plurality of finer cells. The code may also direct the processor to generate a plurality of computational faces associated with each of the plurality of computational cells, wherein each of the computational faces comprises a plurality of finer faces. The code may also direct the processor to associate a first unknown with each of the plurality of computational cells and a second unknown with each of the plurality of computational faces, derive a macro-hybrid mixed finite element discretization on the finest computational mesh, and iterate through a coarsening procedure to transfer known information from the finest computational mesh to a coarsest computational mesh. The code may direct the processor to solve matrix equations to obtain values for each of the first unknowns for each of the plurality of computational cells in the coarsest computational mesh, solve matrix equations to obtain values for each of the second unknowns for each of the plurality of computational faces in the coarsest computational mesh, and iterate through a restoration procedure to restore the values of the primary unknowns to each of the plurality of finer cells and the secondary unknowns to each of the plurality of finer faces. The system may also include a display, wherein the machine readable media includes code configured to generate an image of the reservoir on the display. The reservoir data may include net-to-gross ratio, porosity, permeability, seismic data, AVA parameters, AVO parameters, or any combinations thereof.

Another exemplary embodiment of the present techniques provides a method for hydrocarbon management of a reservoir. The method includes generating a model of a reservoir comprising a plurality of homogenized mixed finite elements in an unstructured computational mesh and coarsening the unstructured computational mesh to form a plurality of coarser computational meshes in the model. A convection-diffusion subsurface process is evaluated on a coarsest computational mesh and a result is transferred from the coarsest computational mesh to a finest computational mesh. A performance parameter for the hydrocarbon reservoir is predicted from the model and the predicted performance parameter is used for hydrocarbon management of the reservoir.

The method may include projecting features of a reservoir onto a horizontal plane to form a projection and creating two-dimensional unstructured computational meshes resolving desired features in the projection. The two-dimensional unstructured computational meshes may be projected onto boundary surfaces in order to define a finest computational mesh. At least one coarser computational mesh may be generated, wherein the coarser computational mesh comprises a plurality of computational cells, and each of the plurality of computational cells comprises a plurality of finer cells. A plurality of computational faces is associated with each of the plurality of computational cells, wherein each of the computational faces includes a plurality of finer faces. A first unknown can be associated with each of the plurality of computational cells and a second unknown can be associated with each of the plurality of computational faces. A macro-hybrid mixed finite element discretization may be derived on the finest computational mesh and an interative coarsening procedure may be performed to transfer known information from the finest computational mesh to a coarsest computational mesh. Matrix equations can be solved to obtain values for each of the first unknowns for each of the plurality of computational cells in the coarsest computational mesh. Matrix equations can also be solved to obtain values for each of the second unknowns for each of the plurality of computational faces in the coarsest computational mesh. An iterative restoration procedure can be performed to restore the values of the primary unknowns to each of the plurality of finer cells and the secondary unknowns to each of the plurality of finer faces.

The hydrocarbon management of the reservoir may include, for example, hydrocarbon extraction, hydrocarbon production, hydrocarbon exploration, identifying potential hydrocarbon resources, identifying well locations, determining well injection rates, determining well extraction rates, identifying reservoir connectivity, or any combinations thereof. The performance parameter may include, for example, a production rate, a pressure, a temperature, a permeability, a transmissibility, a porosity, a hydrocarbon composition, or any combinations thereof.

Another exemplary embodiment provides a tangible, computer readable medium that includes code configured to direct a processor to perform various operations related to coarsening a model. The code can be configured to project features of a reservoir onto a horizontal plane to form a projection and create a two-dimensional unstructured computational mesh resolving desired features in the projection. The code can also be configured to project the two-dimensional unstructured computational mesh onto boundary surfaces in order to define a finest computational mesh that approximates the boundary surfaces and to generate at least one coarser computational mesh, wherein the coarser computational mesh comprises a plurality of computational cells, and each of the plurality of computational cells comprises a plurality of finer cells. The code can also be configured to generate a plurality of computational faces associated with each of the plurality of computational cells, wherein each of the computational faces comprises a plurality of finer faces and to associate a first unknown with each of the plurality of computational cells and associate a second unknown with each of the plurality of computational faces. The code can also be configured to derive a macro-hybrid mixed finite element discretization on the finest computational mesh, to iterate through a coarsening procedure to transfer known information from the finest computational mesh to a coarsest computational mesh and to solve matrix equations to obtain values for each of the first unknowns for each of the plurality of computational cells in the coarsest computational mesh. The code can also be configured to solve matrix equations to obtain values for each of the second unknowns for each of the plurality of computational faces in the coarsest computational mesh and to iterate through a restoration procedure to restore the values of the primary unknowns to each of the plurality of finer cells and the secondary unknowns to each of the plurality of finer faces. The code can also be configured to direct the processor to display a representation of a reservoir.

### DESCRIPTION OF THE DRAWINGS

The advantages of the present techniques are better understood by referring to the following detailed description and the attached drawings, in which:

FIG. 1 is a process flow diagram showing a method of coarsening a geologic model on an unstructured computational mesh, in accordance with an exemplary embodiment of the present techniques;

FIG. 2 is a top view of an exemplary reservoir showing a planar projection of a finest computational mesh over the reservoir, in accordance with an exemplary embodiment of the present techniques;

FIG. 3 is a top view of the exemplary reservoir illustrating a planar projection of the first level of coarsening of the computational mesh, in accordance with an exemplary embodiment of the present techniques;

FIG. 4 is a top view of the exemplary reservoir showing a planar projection of another level of coarsening of the computational mesh, in accordance with an exemplary embodiment of the present techniques;

FIG. 5 is a top view of the exemplary reservoir showing a planar projection of another level of coarsening of the computational mesh, in accordance with an exemplary embodiment of the present techniques;

FIG. 6 is a top view of the exemplary reservoir showing a planar projection of a final level of coarsening to create a coarsest computational mesh, in accordance with an exemplary embodiment of the present techniques;

FIG. 7 is a perspective view of an exemplary reservoir showing the projection of a computational mesh vertically onto boundary surfaces of layers, in accordance with an exemplary embodiment of the present techniques;

FIG. 8 is a perspective view of a computational domain of a reservoir illustrating interfaces between geologic layers, in accordance with an exemplary embodiment of the present techniques;

FIG. 9 is a diagram showing a two-dimensional representation of a domain (Ω) partitioned into subdomains (Ωᵢ, i=1, . . . , 10), in accordance with exemplary embodiments of the present techniques;

FIGS. 10A and 10B are schematic diagrams that show the partitioning of two coarse computational mesh cells (EεΩ_{H}) into multiple fine computational mesh cells (eεΩₕ), in accordance with an exemplary embodiment of the present techniques;

FIGS. 11A and 11B are schematic diagrams that show the partitioning of a vertical quadrilateral face into subfaces, in accordance with an exemplary embodiment of the present techniques;

FIG. 12 is a schematic diagram that shows the partitioning of a vertical triangular face F into subfaces Fₗ, l=1, . . . , 4, in accordance with an exemplary embodiment of the present techniques;

FIG. 13 is a schematic diagram that shows the division of a coarse prism into four fine prisms 1302, in accordance with an embodiment of the present techniques; and

FIG. 14 is a block diagram of a computer system on which software for performing processing operations of embodiments of the present techniques may be implemented.

### DETAILED DESCRIPTION

In the following detailed description section, the specific embodiments of the present techniques are described in connection with preferred embodiments. However, to the extent that the following description is specific to a particular embodiment or a particular use of the present techniques, this is intended to be for exemplary purposes only and simply provides a description of the exemplary embodiments. Accordingly, the present techniques are not limited to the specific embodiments described below, but rather, such techniques include all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Coarsening” refers to reducing the number of cells in simulation models by making the cells larger, for example, representing a larger space in a reservoir. The process by which coarsening may be performed is referred to as “scale-up.” Coarsening is often used to lower the computational costs by decreasing the number of cells in a geologic model prior to generating or running simulation models.

“Common scale model” refers to a condition in which the scale of a geologic model is similar to the scale of a simulation model. In this case, coarsening of the geologic model is not performed prior to simulation.

“Computer-readable medium” or “tangible machine-readable medium” as used herein refers to any tangible storage medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like.

“Exemplary” is used exclusively herein to mean “serving as an example, instance, or illustration.” Any embodiment described herein as “exemplary” is not to be construed as preferred or advantageous over other embodiments.

“Hydrocarbon management” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities.

“Permeability” is the capacity of a rock to transmit fluids through the interconnected pore spaces of the rock. Permeability may be measured using Darcy's Law: Q=(kΔP A)/(μL), wherein Q=flow rate (cm³/s), ΔP=pressure drop (atm) across a cylinder having a length L (cm) and a cross-sectional area A (cm²), μ=fluid viscosity (cp), and k=permeability (Darcy). The customary unit of measurement for permeability is the millidarcy. The term “relatively permeable” is defined, with respect to formations or portions thereof, as an average permeability of 10 millidarcy or more (for example, 10 or 100 millidarcy). The term “relatively low permeability” is defined, with respect to formations or portions thereof, as an average permeability of less than about 10 millidarcy. An impermeable layer generally has a permeability of less than about 0.1 millidarcy.

“Pore volume” or “porosity” is defined as the ratio of the volume of pore space to the total bulk volume of the material expressed in percent. Porosity is a measure of the reservoir rock's storage capacity for fluids. Total or absolute porosity includes all the pore spaces, whereas effective porosity includes only the interconnected pores and corresponds to the pore volume available for depletion.

A “Raviart-Thomas” finite element space of vector-functions is based on the partitioning of a computational space, e.g., into tetrahedrons. See, for example, F. Brezzi and M. Fortin, Mixed and hybrid finite element methods, 1991, or J. E. Roberts and J. M. Thomas, Mixed and hybrid methods, In: Handbook of Numerical Analysis, Vol. 2, 1991, pp. 523-639.

A “geologic model” is a computer-based representation of a subsurface earth volume, such as a petroleum reservoir or a depositional basin. Geologic models may take on many different forms. Depending on the context, descriptive or static geologic models built for petroleum applications can be in the form of a 3-D array of cells, to which geologic and/or geophysical properties such as lithology, porosity, acoustic impedance, permeability, or water saturation are assigned (such properties will be referred to collectively herein as “reservoir properties”). Many geologic models are constrained by stratigraphic or structural surfaces (for example, flooding surfaces, sequence interfaces, fluid contacts, faults) and boundaries (for example, facies changes). These surfaces and boundaries define regions within the model that possibly have different reservoir properties.

“Reservoir simulation model” or “simulation model” refer to a specific mathematical representation of a real hydrocarbon reservoir, which may be considered to be a particular type of geologic model. Simulation models are used to conduct numerical experiments regarding future performance of the field with the goal of determining the most profitable operating strategy. An engineer managing a hydrocarbon reservoir may create many different simulation models, possibly with varying degrees of complexity, in order to quantify the past performance of the reservoir and predict its future performance.

“Scale-up” refers to a process by which a computational mesh of production data is coalesced into a coarser computational mesh, for example, by averaging the properties within a certain range, or by using a fewer number of points where the property values are measured or computed. This procedure lowers the computational costs of making a model of a reservoir.

“Transmissibility” refers to the volumetric flow rate between two points at unit viscosity for a given pressure-drop. Transmissibility is a useful measure of connectivity. Transmissibility between any two compartments in a reservoir (fault blocks or geologic zones), or between the well and the reservoir (or particular geologic zones), or between injectors and producers, can all be useful for understanding connectivity in the reservoir.

### Overview

Exemplary embodiments of the present techniques disclose methods for evaluating the parameters of convection-diffusion subsurface processes within a heterogeneous formation, represented as a set of layers of different thickness stacked together and covered by an unstructured grid, which possesses a hierarchically organized structure. These techniques utilize a mixed finite element method for diffusion-type equations on arbitrary polyhedral grids. See Yu. Kuznetsov and S. Repin, New mixed finite element method on polygonal and polyhedral meshes, Russ. J. Numer. Anal. Math. Modelling, 2003, v. 18, pp. 261-278 (which provides a background for modeling such processes using mixed finite elements). See also O. Boiarkine, V. Gvozdev, Yu. Kuznetsov, and S. Maliassov, Homogenized mixed finite element method for diffusion equations on prismatic meshes, Russ. J. Numer. Anal. Math. Modelling, 2008, v. 23, N5, pp. 423-454, and K. Lipnikov, J. D. Moulton, D. Svyatskiy, A multilevel multiscale mimetic method for two-phase flows in porous media, Journal of Computational Physics 2008, v. 227, pp. 6727-6753 (which provides a technique for applying different discretization method called mimetic discretization, which is analogous in many respects to mixed finite element method in multi-scale environment and, hence, for up-scaling of geologic properties).

The problem of scale-up may be considered on an ensemble of hierarchically organized polyhedral grids (hereinafter termed “computational meshes”). Using various procedures, the information may be systematically transferred from a finest computational mesh to a coarsest computational mesh in the hierarchy. A system of algebraic equations may then be solved on the coarsest computational mesh, thereby reducing the computational demands of the calculations. Using an inverse of the coarsening procedure, the information pertaining to the solution on the coarsest computational mesh is propagated back to the (original) finest computational mesh. For the case of a single prismatic computational mesh, the methodology and the implementation details of such a method for the accurate modeling of the heat transport equation in geologic applications were described in Patent Application No. PCT/US2008/080515, filed 20 Oct. 2008, and titled “Modeling Subsurface Processes on Unstructured Grid.”

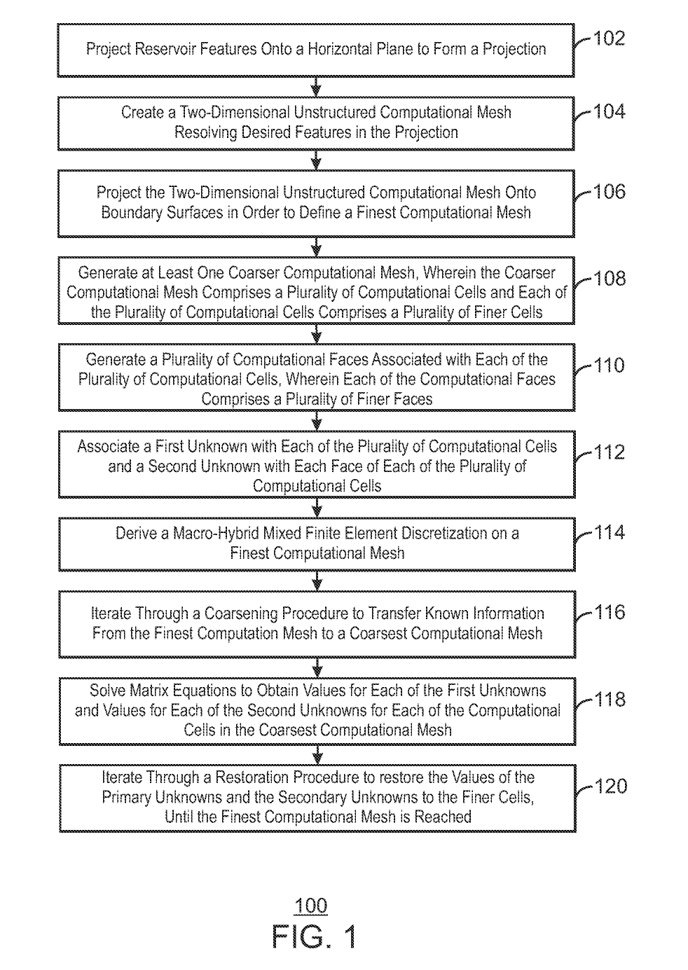

FIG. 1 is a process flow diagram illustrating a method of coarsening a geologic model on an unstructured computational mesh, in accordance with an exemplary embodiment of the present techniques. The method is generally referred to by reference number 100. The method begins at block 102 with the projection of geologic and geometrical features, such as pinch-out boundaries, fault lines, or well locations into a horizontal plane. In an exemplary embodiment the projection is performed orthogonally. In other embodiments, the projection can be non-orthogonal, or slanted.

As indicated at block 104, a two-dimensional unstructured computational mesh can be created to resolve the desired features on that plane. In other embodiments, this may be a hierarchical sequence of two-dimensional unstructured computational meshes. The computational mesh can be comprised of rectangles, polygons, quadrilaterals, or triangles. In an exemplary embodiment, a fine rectangular conforming mesh is generated to cover all features of the projected domain. The rectangular conforming mesh may be the same size as the finest computational mesh on which the material data is provided.

As indicated at block 106, the two-dimensional computational mesh (or hierarchy of computational meshes) may be projected back onto boundary surfaces of layers to construct the prismatic computational mesh. The computational mesh will contain cells, which may include, for example, boxes, hexagons, prisms, tetrahedra, pyramids, and other three dimensional solids, and combinations thereof. Accordingly, the finest computational mesh built in this manner approximates the boundary surfaces of the layers and defines the finest computational mesh of interest. Thus, the physical properties such as permeability or thermal conductivity are defined on that mesh.

As indicated at block 108, at least one coarser computation mesh (or a hierarchy of constructed computational meshes) may be generated to obtain an ensemble of self-embedded, logically-connected coarser computational meshes. Each cell (or computational volume) on a coarse computational mesh may be termed a macro-cell and includes an ensemble of cells on a finer computational mesh. In an exemplary embodiment, the coarsening is performed non-uniformly, to keep fine triangulation near some geologic or geometric features, but obtain coarser resolution away from these features.

As indicated at block 110, a hierarchy of computational faces may be created and associated with the hierarchy of computational cells. Each computational face on a coarse computational mesh, which may be termed a macro-face, is made up of an ensemble of (micro-) faces on a finer computational mesh.

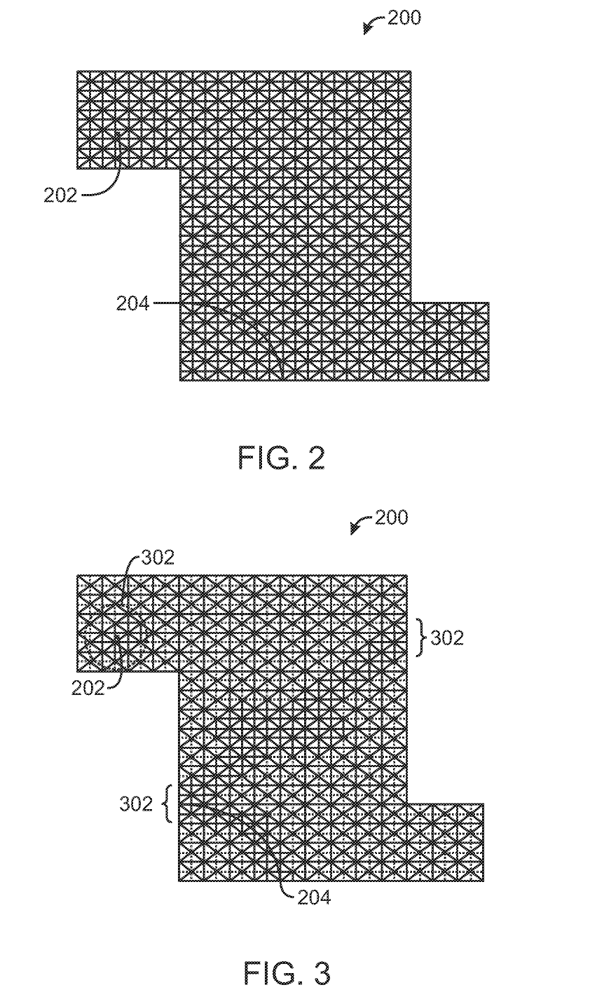

At block 112, a first unknown may be associated with each computational cell, which is considered to be located at the center of the cell. The first unknown generally represents a physical property for the cell, for example, pressure, temperature, or hydrocarbon content, among others. A second unknown may be associated with each face of each cell, and is considered to be located at the face center. The second unknown represents a normal component of a flux between the cells, for example, heat or mass flow across the face of the cell. A macro-hybrid mixed finite element discretization may then be derived for the finest mesh, as indicated by block 114. At block 116, a recursive coarsening/homogenization procedure may be used on the normal components of the flux finite element vector functions to transfer known information and physical properties from the finest computational mesh to the coarsest computational mesh. The coarsening procedure is discussed in greater detail with respect to FIGS. 2-10, below.

The spatial discretization produces a sparse matrix equation on the coarsest computational mesh, which can be called an “up-scaled” equation. At block 118, the sparse matrix equation may be solved for the first and second unknowns on the coarsest computational mesh. At block 120, the solution computed on the coarsest computational mesh may then be used in a recursive procedure to restore the values of the solution function and the flux vector functions to finer computational meshes, which are components of the macro-cells. The iteration is continued until the finest computational mesh is reached. This effectively transfers the solution from the coarsest computational mesh to the finest computational mesh.

FIG. 2 is a top view of an exemplary reservoir showing a planar projection of a finest computation mesh over the reservoir, in accordance with an exemplary embodiment of the present techniques. The projection of the reservoir mesh is generally referred to by the number 200. As shown in FIG. 2, the projection is a two-dimensional computational mesh which may be a uniform triangular grid superimposed over the reservoir. In convection-diffusion type problems in a subsurface formation, the input data may be associated with the nodes (cell intersections) or the cells of the finest computational mesh. Geologic and geometrical features, such as pinch-out boundaries, fault lines 202, or well locations 204 may be projected into the horizontal plane, for example, using orthogonal projection.

FIG. 3 is a top view of the reservoir illustrating a first level of coarsening of the two-dimensional computational mesh, in accordance with an exemplary embodiment of the present techniques. As shown in this figure, the coarsening may be non-uniform in areas 302 that have significant features, such as the projection of a well 202 and the projection of a fault 204. Although the two-dimensional computational mesh is illustrated as a grid of triangles, any number of other shapes may be used, including squares, rectangles, and other types of polyhedra.

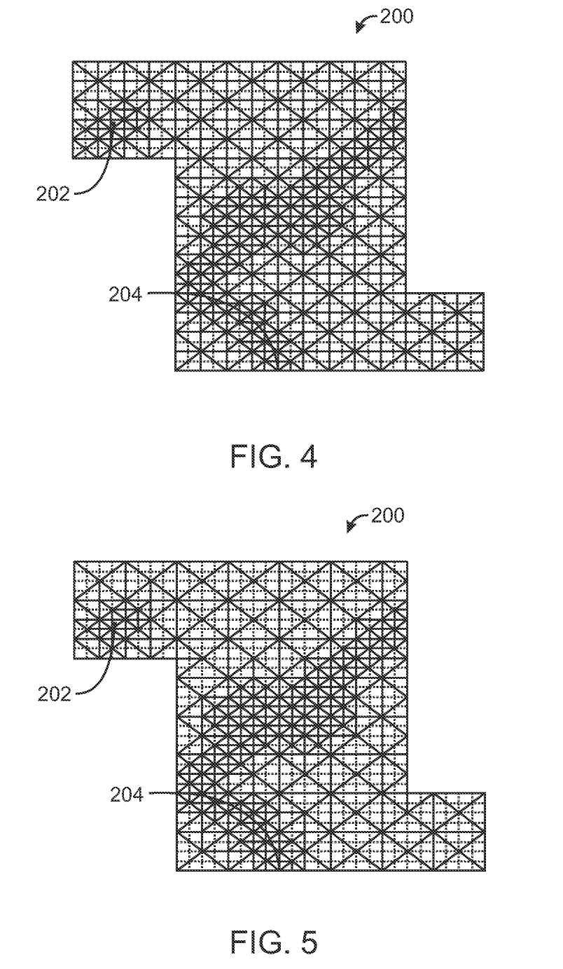

FIG. 4 is a top view of the reservoir showing another level of coarsening of the computational mesh, in accordance with an exemplary embodiment of the present techniques. As discussed with respect to FIG. 3, the finest computational mesh can be retained in the vicinity of significant features, such as the well 202 and fault 204.

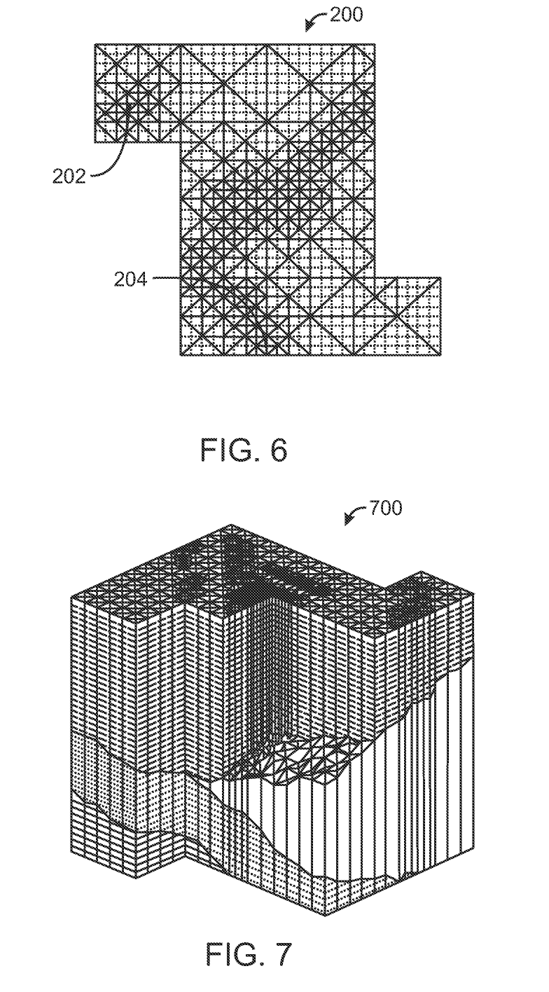

FIG. 5 is a top view of the reservoir showing another level of coarsening to create a coarser computational mesh, in accordance with an exemplary embodiment of the present techniques. FIG. 6 is a top view of the reservoir showing a final level of coarsening to create a coarsest computational mesh, in accordance with an exemplary embodiment of the present techniques. Although FIGS. 2-6 show consecutive levels of coarsening, the method can be applied to an arbitrary hierarchical sequence of computational meshes, for example, to the sequence of computational meshes in FIGS. 2, 4, and 6.

FIG. 7 is a perspective view of an exemplary reservoir showing the projection of a computational mesh vertically onto boundary surfaces of layers, in accordance with an exemplary embodiment of the present techniques. The reservoir is generally referred to by reference number 700. As shown in FIG. 7, the projection constructs a prismatic computational mesh having cells, which can be triangular prisms, tetrahedra, pyramids, hexagons, boxes, or any other three dimensional polyhedral solids. The unstructured prismatic computational mesh built in such a way approximates boundary surfaces of all layers. Once the prismatic computational mesh is constructed, it may be recursively coarsened to generate a sequence of coarser prismatic meshes. Each coarse prismatic mesh represents the original physical domain of interest, although it contains less information than the finest prismatic mesh.

### Problem Formulation

If G is a domain in R² with a regularly shaped boundary ∂G, i.e., piecewise smooth and with angles between the pieces that are greater than 0, then the computational domain Q may be defined as follows:

Ω={(x,y,z)εR³:(x,y)εG,Zₘᵢₙ(x,y)≦z≦Zₘₐₓ(x,y)}, Eqn. 1

wherein Zₘᵢₙ(x,y) and Zₘₐₓ(x,y) are smooth surfaces. Let N_{z} be a positive integer and z=Zᵢ(x,y), i=0, . . . , N_{z}, be single-valued continuous functions defined on G such that:

Z₀(x,y)≡Zₘᵢₙ(x,y) in G̅

Zᵢ₋₁(x,y)≦Zᵢ(x,y) in G̅ i=1, N_{z}.

Z_{N}_{_{z}}(x,y)≡Zₘₐₓ(x,y) in G̅ Eqn. 2

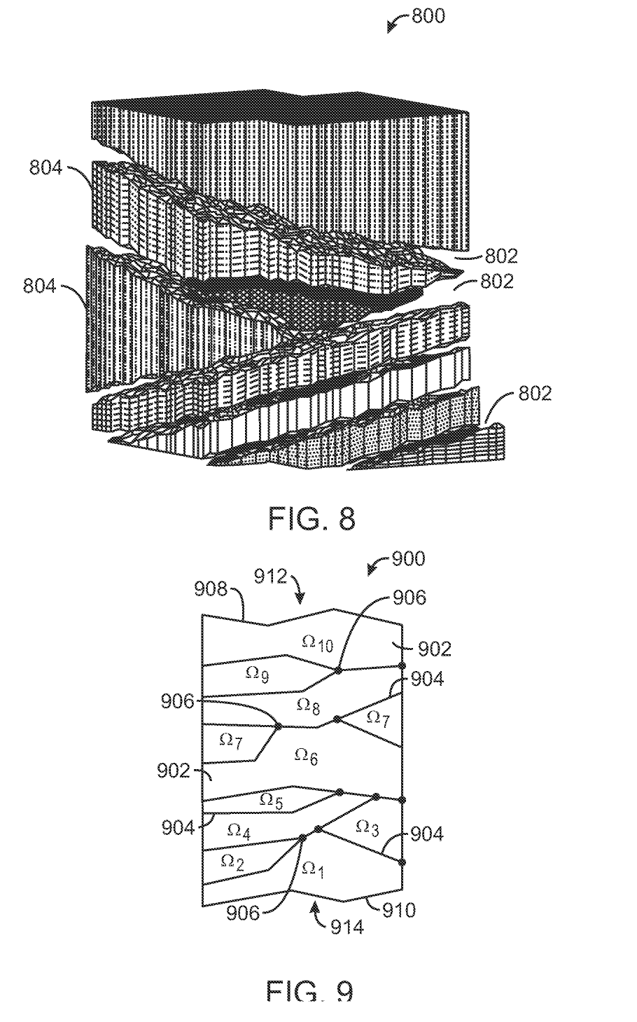

FIG. 8 is a perspective view of a computational domain of an exemplary reservoir illustrating interfaces between geologic layers, in accordance with an exemplary embodiment of the present techniques. The computational domain is generally referred to by the reference number 800. Eqns. 1 and 2 may be used to define the interfaces 802 between geologic layers. In other words, the computational domain (Ω) 800 can be split into N_{z} subdomains 804 (strips or layers) which are defined as follows for all i=1, . . . , N_{z}:

Ωᵢ={(x,y,z)εΩ:(x,y)εG,Zᵢ₋₁(x,y)≦z≦Zᵢ(x,y)}. Eqn. 3

It can be assumed that subdomains Ωᵢ 804, satisfy a cone condition, i.e., the boundaries of the subdomains 804 do not have singular points (zero angles, etc) and, in addition, that all the sets:

G_{i,i-1}={(x,y)ε G̅:Zᵢ₋₁(x,y)=Zᵢ(x,y),(x,y)εG} Eqn. 4

consist of either no polygons or a finite number of polygons.

FIG. 9 is a two-dimensional representation of a vertical cross-section of an exemplary domain (Ω) 900 partitioned into subdomains 902 (Ωᵢ, i=1, . . . , 10), in accordance with exemplary embodiments of the present techniques. The interfaces (or surfaces) 904 between subdomains Ωᵢ₋₁ and Ωᵢ may be denoted by I_{i-1,i}, and the sets

P_{i-1,i}={(x,y,z):z=Zᵢ₋₁(x,y)=(x,y)=Zᵢ(x,y),(x,y)εG} Eqn. 5

may be described as “pinch-outs” 906, i=1, . . . , N_{z}. As used herein, a pinch-out 906, P_{i-1,i} may have nonzero intersection either with P_{i-2,i-1} or with P_{i,i+1}, or with both. The boundary of corresponding set P_{i-1,i} may be denoted by ∂P_{i-1,i}. To simplify the discussion, it may be assumed that pinch-outs (P_{i-1,i}) 906 are simply connected sets.

### Definition of a Coarse Prismatic Mesh

If G_{H} is a conforming coarse triangular computational mesh in G, in other words, any two different triangles in G_{H} have either a common edge, a common vertex, or do not touch each other, then a set of continuous piecewise linear surfaces 904 may be defined in Ω 900 as:

Z=Z_{H,k}(x,y), Eqn. 6

wherein Z_{H,k}(x,y) are single-valued functions defining surfaces 904, k=0, . . . , K, and K is a positive integer. It can be assumed that the top surface 908 (Z_{H,0}(x,y)) and bottom surface 910 (Z_{H,K}(x,y)), coincide with the top boundary 912 (Zₘᵢₙ(x,y)) and bottom boundary 914 (Zₘₐₓ(x,y)) of the original domain. In other words, that:

Z_{H,0}(x,y)=Zₘᵢₙ(x,y),Z_{H,K}(x,y)=Zₘₐₓ(x,y) in G Eqn. 7

and

Z_{H,k-1}(x,y)≦Z_{H,k}(x,y), in G,k=1, . . . ,K. Eqn. 9

Two major assumptions can then be imposed on the set of the surfaces 904 {Z_{H,k}}. First, that the surfaces Z_{H,k} do not cross the surfaces Zᵢ, in other words, for any integer k, 1≦k≦K, an integer i, 1≦i≦N_{z}, exists such that:

Zᵢ₋₁(x,y)≦Z_{H,k}(x,y)≦Zᵢ(x,y) Eqn. 10

for all (x,y) from G. Second, that if the surface 904 Z_{H,k}, 1≦k≦K, satisfies the inequalities of the first assumption, then any two neighboring surfaces 904 Z_{H,k-1} and Z_{H,k}, 1≦k≦K, do not create mutual pinch-outs 906 in additional to the pinch-outs 906 P_{i-1,i}, 1≦i≦N_{z}. In other words, that:

Z_{H,k-1}(x,y)≦Z_{H,k}(x,y) Eqn. 11

for all (x,y) from G\G_{i-1,i}. The term Z_{H,k}, 0≦k≦K may be used to indicate the “lateral” coarse mesh surfaces 904.

The coarse computational mesh Ω_{H} in Ω 900 is defined by intersections of coarse mesh surfaces z=Z_{H,k}(x,y), 0≦k≦K, with the set of infinite prisms {E_{G}×(−∞, +∞)}, wherein E_{G} is a particular triangle in G_{H}. Ω_{H} is conforming and consists of coarse computational mesh cells (macro-cells) E. The surfaces z=Zᵢ(x,y) and z=Z_{H,k} (x,y) may be assumed to be planar for each cell E_{G} in G_{H}. After these assumptions are made, each computational mesh cell EεΩ_{H} is either a “vertical” prism with two “lateral” and three vertical nonzero faces, or a degenerated “vertical” prism when there is one or two zero vertical edges. A degenerated computational mesh cell is either a pyramid (one vertical edge is zero) or a tetrahedron (two vertical edges are zero). To simplify the calculation, the surfaces Zᵢ, 0≦i≦N_{z}, and Z_{H,k}, 0≦k≦K, may be assumed to be “almost planar” for each computational mesh cell E_{G} in G_{H}. Thus, they can be approximated with reasonable accuracy by surfaces which are planar for each E_{G} in G_{H}.

### Definition of a Fine Prismatic Mesh

As for the coarse computational mesh, a fine computational mesh may be defined in Ω 900 with the help of the set of continuous piecewise linear surfaces:

z=Z_{h,j}(x,y), Eqn. 12

wherein Z_{h,j}(x,y) are single-valued functions defining surfaces, j=0, . . . , J, and J is a positive integer. It can be assumed that the top surface 908 (Z_{h,0}(x,y)) and bottom surface 910 (Z_{h,J}(x,y)), coincide with the top boundary 912 (Zₘᵢₙ(x,y)) and bottom boundary 914 (Zₘₐₓ(x,y)) of the original domain, respectively. Thus, that:

Z_{h,0}(x,y)=Zₘᵢₙ(x,y),Z_{h,J}(x,y)=Zₘₐₓ(x,y) in G Eqn. 13

and

Z_{h,j-1}(x,y)≦Z_{h,j}(x,y), in G,j=1, . . . , J. Eqn. 14

It can also be assumed that all surfaces {Zᵢ} and {Z_{H,k}} belong to the set of surfaces {Z_{h,j}}. Thus, surfaces {Z_{h,j}}, j=1, . . . , J, do not cross any surfaces from the sets {Zᵢ} and {Z_{H,k}}. Then, it can be assumed that any two neighboring surfaces Z_{h,j-1} and Z_{h,j}, 1≦j≦J, belonging to the same layer Ωⱼ (for example, layer 902), coincide only in points (x,y)εG_{i-1,i}, i.e.

Z_{h,j-1}(x,y)≦Z_{h,j}(x,y), Eqn. 15

for all (x,y) from G\G_{i-1,i}.

Gₕ can be considered to be a conforming triangular mesh in G such that each triangle E_{G}εG_{H} is a union of triangles in Gₕ. In other words, Gₕ is a triangular refinement of the coarse mesh G_{H}. Accordingly, the fine mesh Ωₕ in Ω may then be defined by the intersection of the fine mesh surfaces z=Z_{h,j} (x,y), j=0, . . . , J, with the set of infinite vertical prisms {e_{G}×(−∞, +∞)}, in which e_{G} is a particular triangle in Gₕ. Ωₕ is conforming and consists of fine mesh cells (micro-cells) e. It can then be assumed that the subsurfaces z=Z_{h,j} (x,y), (x,y)εe_{G} are planar for each triangle e_{G}εGₕ. Accordingly, each mesh cell eεΩₕ is either a “vertical” prism with two “lateral” and three vertical faces, or a quadrilateral pyramid, or a tetrahedron. According to the definition of the fine mesh Ωₕ, each coarse mesh cell EεΩ_{H} is a union of fine mesh cells eεΩₕ.

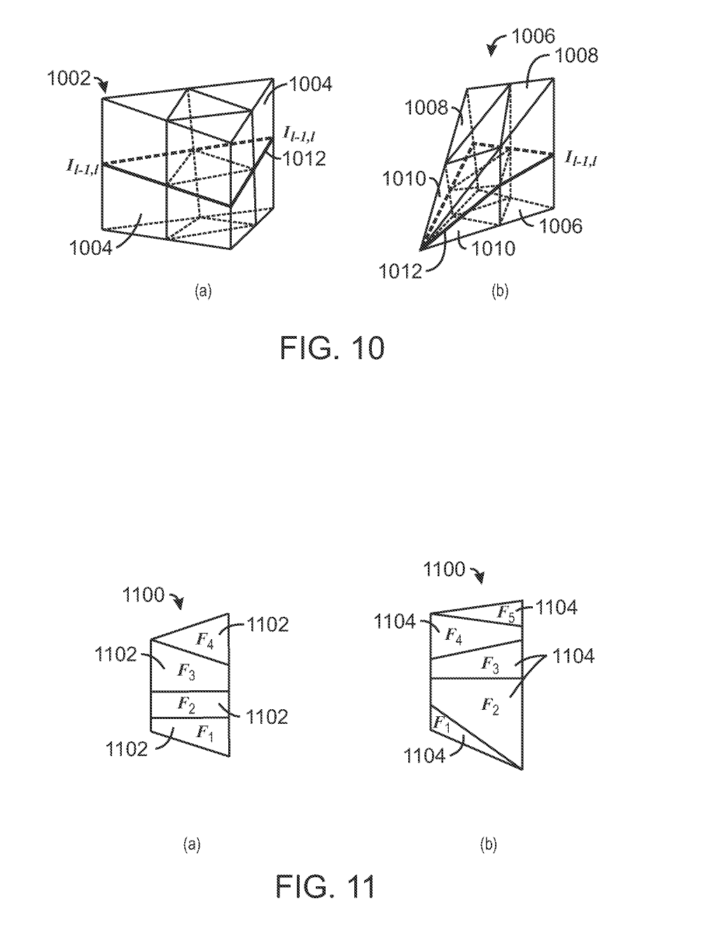

FIGS. 10A and 10B are illustrations showing the partitioning of two coarse computational mesh cells (EεΩ_{H}) into multiple fine computational mesh cells (eεΩₕ), in accordance with an exemplary embodiment of the present techniques. As shown in FIG. 10A a prism 1002 (EεΩ_{H}) may be partitioned into eight fine prisms 1004 (eεΩₕ). FIG. 10B illustrates the partitioning of a pyramid 1006 (EεΩ_{H}) into six fine prisms 1008 and two fine pyramids 1010 (eεΩₕ). The bold lines 1012 indicate the intersections of E with the interface boundary I_{i-1,i} between Ωᵢ₋₁ and Ωᵢ.

### Differential Equations

Exemplary embodiments of the present techniques can be used to coarsen computational meshes that represent convection-diffusion processes. For simplicity, this procedure can be described by using an exemplary 3D diffusion type equation:

−∇·(K∇p)+c·p=ƒ in Ω, Eqn. 16

wherein p is an unknown function (which can, for example, be the pressure in the computational cell), K=K(x) is a diffusion tensor, c is a nonnegative function, ƒ is a source function, and Ω⊂R³ is a bounded computational domain. It can be assumed that K is a uniformly positive definite matrix and that the boundary ∂Ω of the domain Ω is partitioned into two non-overlapping sets Γ_{D} and Γ_{N}.

Eqn. 16 is complemented with the boundary conditions shown in Eqns. 17:

p=g_{D} on Γ_{D},

(K∇p)·n+σ·p=g_{N} on Γ_{N} Eqn. 17

wherein n is the outward unit normal vector to Γ_{N}, σ is a nonnegative function, and g_{D} and g_{N} are given functions. The problem presented in Eqns. 16 and 17 can be assumed to have a unique solution.

The differential problem in Eqns. 16-17 can be replaced by the equivalent first order system:

u+K∇p=0 in Ω

∇·u+c·p=ƒ in Ω′ Eqn. 18

p=g_{D} on Γ_{D}.

−u·n+σ·p=g_{N} on Γ_{N} Eqn. 19

Thus, the problem illustrated by Eqns. 18 and 19 can be described as the mixed formulation of the problem illustrated by Eqns. 16 and 17. Note that in this way that both the primary unknown p and its flux u are simultaneously approximated.

### Variational Mixed Formulation

The variational mixed formulation of the differential problem illustrated in Eqns. 18 and 19 can be stated as follows: find uεĤ_{div}(Ω), pεL₂(Ω), and λεL₂(Γ_{N}) such that

$${\int }_{Ω} ( {K}^{- 1} u ) \cdot v d x - {\int }_{Ω} p ( ∇ \cdot v ) d x + {\int }_{{Γ}_{N}} λ ( v \cdot n ) d s = - {\int }_{{Γ}_{D}} {g}_{D} ( v \cdot n ) d s \\ - {\int }_{Ω} ( ∇ \cdot u ) q d x - {\int }_{Ω} c \cdot pq d x = - {\int }_{Ω} fq d x \\ {\int }_{{Γ}_{N}} ( u \cdot n ) μ d s - {\int }_{{Γ}_{N}} σλμ d s = {\int }_{{Γ}_{N}} {g}_{N} μ d s , \qquad Eqn . 20$$

for all vεĤ_{div}(Ω), qεL₂(Ω), and μεL₂(Γ_{N}), wherein

$${\hat{H}}_{div} ( Ω ) = \{ v : v ∈ {[ {L}_{2} ( Ω ) ]}^{3} , ∇ \cdot v ∈ {L}_{2} ( Ω ) , {\int }_{\partial Ω} {\vert v \cdot n \vert}^{2} d s < ∞ \} .$$

In this formulation, λ is the restriction of the pressure function p=p(x) onto Γ_{N}, and the boundary conditions are natural.

In the case of σ=0 on Γ_{N}, the variational mixed formulation can be stated in the following form: find uεĤ_{div}(Ω), u·n=−g_{N} on Γ_{N} and pεL₂(Ω) such that

$${\int }_{Ω} ( {K}^{- 1} u ) \cdot v d x - {\int }_{Ω} p ( ∇ \cdot v ) d x = - {\int }_{{Γ}_{D}} {g}_{D} ( v \cdot n ) d s \\ {\int }_{Ω} ( ∇ \cdot u ) q d x + {\int }_{Ω} c \cdot pq d x = {\int }_{Ω} fq d x , \qquad Eqn . 21$$

for all vεĤ_{div}(Ω), v·n=0 on Γ_{N} and qεL₂(Ω). In the following specific descriptions, the formulation in Eqn. 20 is considered, although all conclusions can be applied to the formulation in Eqn. 21 without loss of generality.

### Macro-Hybrid Mixed Formulation

If Ω is partitioned into m non-overlapping polyhedral subdomains Eₛ, with boundaries ∂Eₛ and interfaces between boundaries Γₛₜ=∂Eₛ∩∂Eₜ, s,t=1, . . . , m, then in exemplary embodiments, the subdomains may be considered to be coarse computational mesh cells EεΩ_{H} or fine computational mesh cells eεΩₕ. It can be assumed that all nonzero interfaces Γₛₜ are simply connected pieces of piece-wise planar surfaces, s,t=1, . . . , m. Thus, the union of all nonzero interfaces Γₛₜ may be denoted by Γ, in other words, Γ=∪Γₛₜ and the intersections of Γ_{N} with Eₛ may be denoted by Γ_{N,s}, s=1, . . . , m.

Let the terms Vₛ=H_{div}(Eₛ), Qₛ=L₂(Eₛ), Λ_{N,s}=L₂(Γ_{N,s}), and Λₛₜ=L₂(Γₛₜ) be the spaces of vector-functions u and functions p defined in Eₛ, and let functions λ be defined on Γ_{N,s} and functions λ be defined on Γₛₜ, s,t=1, . . . , m, respectively. New spaces can then be defined as:

$$V = {V}_{1} \times {V}_{2} \times … \times {V}_{m} \\ Q = {Q}_{1} \times {Q}_{2} \times … \times {Q}_{m} \\ {Λ}_{N} = {Λ}_{N , 1} \times {Λ}_{N , 2} \times … \times {Λ}_{N , m} \\ {Λ}_{Γ} = {\prod }_{1 \leq s \leq t \leq m} {Λ}_{st} \\ Λ = {Λ}_{Γ} \times {Λ}_{N} . \qquad Eqn . 22$$

Accordingly, the macro-hybrid mixed formulation of the differential problems shown in Eqns. 18 and 19 reads as follows: find (u, p, λ)εV×Q×Λ, such that the equations in Eₛ:

$${\int }_{{E}_{s}} ( {K}^{- 1} {u}_{s} ) \cdot {v}_{s} d x - {\int }_{{E}_{s}} {p}_{s} ( ∇ \cdot {v}_{s} ) d x + {\int }_{{Γ}_{s}} λ ( {v}_{s} \cdot {n}_{s} ) d s = - {\int }_{{Γ}_{D , s}} {g}_{D} ( {v}_{s} \cdot {n}_{s} ) d s \\ - {\int }_{{E}_{s}} ( ∇ \cdot {u}_{s} ) {q}_{s} d x - {\int }_{{E}_{s}} c \cdot {p}_{s} {q}_{s} d x = - {\int }_{{E}_{s}} {fq}_{s} d x , \qquad Eqn . 23$$

wherein s=1, . . . , m, with the variation equations of the continuity of normal fluxes on Γₛₜ:

$${\int }_{{Γ}_{st}} [ {u}_{s} , {n}_{s} + {u}_{t} \cdot {n}_{t} ] {μ}_{st} d s = 0 , s , t = 1 , … , m , \qquad Eqn . 24$$

and with the variation equations for the Neumann boundary condition:

$${\int }_{{Γ}_{N , s}} ( {u}_{s} \cdot {n}_{s} ) {μ}_{N , s} d s = {\int }_{{Γ}_{N , s}} {g}_{N} {μ}_{N , s} d s , \qquad Eqn . 25$$

s=1, . . . , m, are satisfied for any (v, q, μ)εV×Q×Λ. Here, nₛ is the unit outward normal to ∂Eₛ, and Γₛ=∂Eₛ\Γ_{D}, Γ_{D,s}=∂Eₛ∩F_{D} are the non-Dirichlet and the Dirichlet parts of the boundary ∂Eₛ, respectively, s=1, . . . , m. Thus, uₛεVₛ and pₛεQₛ are functional components of uεV and pεQ in Eₛ, respectively, s=1, . . . , m.

### Mixed Finite Element Method on Prismatic Meshes and the Definition of “Div-Const” Finite Element Spaces on Micro-Cells

As previously discussed, the computational mesh Ωₕ consists of elements {eₖ} which are either vertical prisms, or pyramids, or tetrahedrons. To formulate the mixed finite element (MFE) method for the problem shown in Eqns. 23-25, the finite element subspaces of the spaces Vₕ, Qₕ, and Λₕ have to be defined.

To define the finite element space for the flux vector-functions, it can be assumed that each prismatic computational mesh cell eεΩₕ is partitioned into three tetrahedrons Δ₁, Δ₂, and Δ₃, and each pyramidal computational mesh cell eεΩₕ is partitioned into two tetrahedrons Δₗ and Δ₂. Thus, RT₀(e) may denote the classical lowest order Raviart-Thomas finite element space of vector-functions based on the above partitioning of e into tetrahedrons.

If e is a computational mesh cell in Ωₕ with s planar faces fᵢ, i=1, . . . , s, then s=5 for “vertical” prisms and pyramids and s=4 for tetrahedrons. The finite element space Vₕ(e) on e for the flux vector-functions may then be defined as:

Vₕ(e)={vₕ:vₕεRT₀(e),vₕ·nₑ=constᵢ on fᵢ,i= 1̅,̅s̅,∇·vₕ=const in e}.

Here, nₑ is the outward unit normal to the boundary ∂e of e.

The finite element space Qₕ(e) can be defined for the solution function p by:

Qₕ(e)={qₕ:qₕ=const in e}.

If E is a macro-cell in Ω_{H}, then E can be assumed to be a union of micro-cells eεΩₕ. The finite element space Vₕ(E) can be defined as the set of vector-functions vₕ which satisfy two conditions. First, that vₕ|ₑεVₕ(e) for any e⊂E and, second, that the normal components of vₕ are continuous on the interface between any two neighboring fine mesh cells e, e′⊂c E. Thus, the finite element space Qₕ(E) for the solution function can be defined by:

Qₕ(E)={qₕ:qₕ|ₑεQₕ(e) for all e⊂E}.

The global finite element spaces for the flux vector-function and the solution function on Ωₕ partitioned into macro-cells Eₛ, s=1, . . . , m, can be defined in a similar fashion to Eqn. 22, as Vₕ=V_{h,1}×V_{h,2}× . . . ×V_{h,m} and Qₕ=Q_{h,1}×Q_{h,2}× ×Q_{h,m}, respectively. Here V_{h,s}=Vₕ(Eₛ) and Q_{h,s}=Qₕ(Eₛ), s=1, . . . , m. Further, the finite element space Λₕ≡Λₕ (Γ∪Γ_{N}) for the Lagrange multipliers is defined by:

Λₕ={λₕ:λₕ|_{f}≡const_{f} on any face f in Ωₕ, such that f⊂Γ∪Γ_{N}}.

### Macro-Hybrid Mixed Finite Element Method on Ω_{H}

The macro-hybrid mixed finite element discretization of the problem illustrated in Eqns. 23-25 can be described as: find (uₕ, pₕλₕ)εVₕ×Qₕ×Λₕ such that the equations in Eₛ:

$${\int }_{{E}_{s}} ( {K}^{- 1} {u}_{h , s} ) \cdot {v}_{s} d x - {\int }_{{E}_{s}} {p}_{h , s} ( ∇ \cdot {v}_{s} ) d x + {\int }_{{Γ}_{s}} {λ}_{n} ( {v}_{s} \cdot {n}_{s} ) d s = - {\int }_{{Γ}_{D , s}} {g}_{D} ( {v}_{s} \cdot {n}_{s} ) d s \\ - {\int }_{{E}_{s}} ( ∇ \cdot {u}_{h , s} ) {q}_{s} d x - {\int }_{{E}_{s}} c \cdot {p}_{h , s} {q}_{s} d x = - {\int }_{{E}_{s}} {fq}_{s} d x \qquad Eqn . 26$$

s=1, . . . , m, with the variation equations of the continuity of normal fluxes on Γₛₜ:

$${\int }_{{Γ}_{st}} [ {u}_{h , s} \cdot {n}_{s} + {u}_{h , t} \cdot {n}_{t} ] {μ}_{st} d s = 0 , s , t = 1 , … , m , \qquad Eqn . 27$$

and with the variation equations for the Neumann boundary condition:

$${\int }_{{Γ}_{N , s}} ( {u}_{h , s} \cdot {n}_{s} ) {μ}_{N , s} d s = {\int }_{{Γ}_{N , s}} {g}_{N} {μ}_{N , s} d s , \qquad Eqn . 28$$

s=1, . . . , m, are satisfied for any (v, q, μ)εVₕ×Qₕ×Λₕ.

The finite element problem illustrated by Eqns. 26-28 results in the algebraic equations:

Mₛūₛ+Bₛ^{T} p̅ₛ+Cₛ^{T} λ̅= g̅_{D,s},

Bₛūₛ−Σₛ p̅ₛ= f̅ₛ Eqn 29

s=1, . . . , m, complemented by the algebraic equations

$$C \cdot [ \begin{matrix}{\overline{u}}_{1} \\ ⋮ \\ {\overline{u}}_{m}\end{matrix} ] = {\overline{g}}_{N} \qquad Eqn . 30$$

Eqns. 29 and 30 represent the continuity conditions for the normal fluxes on the interfaces between neighboring macro-cells in Ω_{H} and the Neumann boundary condition on Γ_{N}. Here, Mₛ is a square n_{u,s}×n_{u,s} symmetric positive definite matrix (the mass matrix in the space of fluxes), Bₛ is a rectangular n_{p,s}×n_{p,s} matrix, Cₛ^{T} is a rectangular n_{u,s}×n_{λ} matrix, Σₛ is a diagonal n_{p,s}×n_{p,s} matrix wherein n_{u,s}=dim V_{h,s} and n_{p,s}=dim Q_{h,s}, s=1, . . . , m, and n_{λ}=dim Λₕ.

The system illustrated in Eqns. 29 and 30 can be presented in a more compact form as:

$$( \begin{matrix}M & {B}^{T} & {C}^{T} \\ B & - Σ & 0 \\ C & 0 & 0\end{matrix} ) ( \begin{matrix}\overline{u} \\ \overline{p} \\ \overline{λ}\end{matrix} ) = ( \begin{matrix}{\overline{g}}_{D} \\ \overline{f} \\ {\overline{g}}_{N}\end{matrix} ) , \qquad Eqn . 31$$

wherein M=M₁⊕M₂⊕ . . . ⊕Mₘ and B=B₁⊕B₂⊕ . . . ⊕Bₘ are m×m block diagonal matrices,

$$C = ( {C}_{1} … {C}_{m} ) , \overline{u} = ( \begin{matrix}{\overline{u}}_{1} \\ ⋮ \\ {\overline{u}}_{m}\end{matrix} ) , \overline{p} = ( \begin{matrix}{\overline{p}}_{1} \\ ⋮ \\ {\overline{p}}_{m}\end{matrix} ) , \\ and \overline{λ} ∈ {R}^{{n}_{λ}} .$$

Discretization on Ω_{H} with Coarse Finite Element Spaces

Let Eₛ, s=1, . . . , m, be a macro-cell in Ω_{H} with faces F_{s,j}, j=1, . . . , wherein rₛ equals to either 5 or 4 (for example, representing a prismatic or pyramidal cell). The finite element space Vₕ(Eₛ) defined previously can then be presented as a direct sum of (rₛ+1) subspaces:

Vₕ(Eₛ)=W_{h,s,1}⊕W_{h,s,2}⊕ . . . ⊕W_{h,s,r}_{ₛ}⊕W_{h,s,int}, Eqn. 32

wherein the space W_{h,s,j} is associated with degrees of freedom (DOF) for the normal fluxes on the face F_{s,j}, j=1, . . . , rₛ, and the space W_{h,s,int} is associated with interior degrees of freedom for the normal fluxes in the interior of Eₛ.

If {w_{j,i}} is a basis in W_{h,s,j}, j=1, . . . , rₛ, and is a basis in W_{h,s,int}, then, for a vector-function vεVₕ(Eₛ), the vector of degrees of freedom v with respect to these bases can be presented by:

ν^{T}=(ν₁^{T},ν₂^{T}, . . . νᵣ_{ₛ}^{T},νᵢₙₜ^{T}). Eqn. 33

If Ŵ_{h,s,j} is a subspace of W_{h,s,j}, j=1, . . . , rₛ, and Ŵ_{h,s,int} is a subspace of W_{h,s,int}, then a basis in Ŵ_{h,s,j}, j=1, . . . , rₛ can be denoted as {ŵ_{j,i}}, and a basis in Ŵ_{h,s,int} can be denoted as {ŵ_{int,i}}. Accordingly, for a vector-function v belonging to the space:

\hat{V}_{h,s}≡\hat{V}ₕ(Eₛ)=Ŵ_{h,s,1}⊕Ŵ_{h,s,2}⊕ . . . ⊕Ŵ_{h,s,r}_{ₛ}⊕Ŵ_{h,s,int}, Eqn. 34

the vector ν_{c}^{T} of degrees of freedom with respect of these bases can be presented by:

ν_{c}^{T}=(ν_{c,1}^{T},ν_{c,2}^{T}, . . . ν_{c,r}_{ₛ}^{T},ν_{c,int}^{T}). Eqn. 35

Vₕ(Eₛ) may be termed a fine finite element space and \hat{V}ₕ(Eₛ) may be termed a coarse finite element space. For this representation, the bottom index c is used for the coarse space of degrees of freedom.

The selection of the above bases uniquely defines (rₛ+1) transformation matrices R_{s,j},j=1, . . . , rₛ, and R_{s,int}, such that:

νⱼ=R_{s,j}·ν_{c,j}, j=1, . . . ,rₛ, and νᵢₙₜ=R_{s,int}·ν_{c,int}. Eqn. 36

The transformation matrices for the spaces Vₕ(Eₛ) and \hat{V}ₕ(Eₛ) can be defined by:

Rₛ=R_{s,1}⊕R_{s,2}⊕ . . . ⊕R_{s,r}_{ₛ}⊕R_{s,int}. Eqn. 37

Further, the global coarse space of vector functions can be introduced by:

V_{H}=V_{H,1}×V_{H,2}× . . . ×V_{H,m}, Eqn. 38

wherein V_{H,s}=\hat{V}ₕ(Eₛ), s=1, . . . , m. Thus, the vectors of degrees of freedom ν and ν_{c} for a finite element vector-function νεV_{H} associated with bases in Vₕ and V_{H}, respectively, satisfy the transformation:

ν=R·ν_{c}, Eqn. 39

wherein R is the m×m block diagonal matrix R=R₁×R₂× ×Rₘ.

To define the coarse finite element space for the Lagrange multipliers in Eqns. 23-25, it can be assumed that the normal traces of the finite element spaces \hat{V}ₕ(Eₛ) and \hat{V}ₕ(E′ₛ) on the interface F=∂E∩∂E′ between two neighboring macro-cells E and E′ in Ω_{H} coincide. More specifically, it can be assumed that the normal traces on F of the selected basis vector-functions in \hat{V}ₕ(Eₛ) and \hat{V}ₕ(E′ₛ) also coincide.

If F represents the interface between two neighboring macro-cells E and E′ in Q_{H}, then, without loss of generality, this interface may be associated with the face F_{E,1} of E. The coarse finite element subspace Ŵ_{h,E,1} of \hat{V}ₕ(Eₛ) is also associated with F as well as the basis vector-functions ŵ_{1,j}, i=1, . . . , n_{F}, wherein n_{F}=dim Ŵ_{h,E,1}. A set of functions: {\hat{ψ}_{1,i}=ŵ_{E,1,i}·n_{E}}, i=1, . . . , n_{F}, can then be defined on F. By construction these functions are linearly independent. Then, the space is defined as Λ_{H}(F)=span{\hat{ψ}_{1,1}, . . . , \hat{ψ}_{1,n}_{_{F}}}, in other words, the set {ψ1,i} is a basis in Λ_{H}(F). Due to the assumption that the sets of the normal traces on F of the vector functions from \hat{V}_{H}(E) and from \hat{V}_{H}(E′) coincide, the spaces Λ_{H}(F) defined on F in E and E′, also coincide.

The finite element space Λ_{H} for the Lagrange multipliers may be defined as the set of piecewise constant functions λ_{H} defined on Γ∪Γ_{N}, such that λ_{H}|_{F}εΛ_{H}(F) on all interfaces F between neighboring macro-cells E and E′ in Ω_{H} as well as on the macro-faces F belonging to Γ_{N}. If F=F_{s,1} is a face of a macro-cell EₛεΩ_{H}, s=1, . . . , m, then it can be shown that for the latter definition of the spaces Λ_{H}(F) and Λ_{H}, the transformation matrix R_{λ,F} between the spaces Λₕ(F) and Λ_{H}(F) coincides with the transformation matrix R_{s,1} in Eqn. 37, and the transformation matrix between the global spaces Λₕ and Λ_{H} can be defined by R_{λ}=_{F}^{⊕}R_{λ,F}, wherein the direct summation ⊕ is taken over all different macro-faces on Γ∪Γ_{N}.

Thus, the vectors λ and λ_{c} of degrees of freedom for the spaces Λₕ and Λ_{H} satisfy the transformation:

λ=R_{λ}·λ_{c}. Eqn. 40

Finally, the coarse space of the solution functions may be simply defined as:

Q_{H}=Qₕ Eqn. 41

The macro-hybrid mixed finite element discretization represented in Eqns. 23-25 may then be read as: find (uₕ, p_{H}, λₕ)εV_{H}×Q_{H}×Λ_{H} such that the equations in Eₛ:

$${\int }_{{E}_{s}} ( {K}^{- 1} {u}_{H , s} ) \cdot {v}_{s} d x - {\int }_{{E}_{s}} {p}_{H , s} ( ∇ \cdot {v}_{s} ) d x + {\int }_{{Γ}_{s}} {λ}_{H} ( {v}_{s} \cdot {n}_{s} ) d s = - {\int }_{{Γ}_{D , s}} {g}_{D} ( {v}_{s} \cdot {n}_{s} ) d s \\ - {\int }_{{E}_{s}} ( ∇ \cdot {u}_{H , s} ) {q}_{s} d x - {\int }_{{E}_{s}} c \cdot {p}_{H , s} {q}_{s} d x = - {\int }_{{E}_{s}} {fq}_{s} d x , \qquad i . Eqn . 42$$

s=1, . . . , m, with the variation equations of the continuity of normal fluxes on Γₛₜ:

$${\int }_{{Γ}_{st}} [ {u}_{H , s} \cdot {n}_{s} + {u}_{H , t} \cdot {n}_{t} ] {μ}_{st} d s = 0 , s , t = 1 , … , m , \qquad Eqn . 43$$

and the variation equations for the Neumann boundary condition:

$${\int }_{{Γ}_{N , s}} ( {u}_{H , s} \cdot {n}_{s} ) {μ}_{N , s} d s = {\int }_{{Γ}_{N , s}} {g}_{N} {μ}_{N , s} d s , \qquad Eqn . 44$$

s=1, . . . , m, are satisfied for any (v, q, μ)εV_{H}×Q_{H}×Λ_{H}.

The finite element problem in Eqns. 42-44 results in the algebraic equations:

\hat{M}ₛūₛ+\hat{B}ₛ^{T} p̅ₛ+Ĉₛ^{T} λ̅= g̅_{D,s},

\hat{B}ₛūₛ−Σₛ p̅ₛ= f̅ₛ Eqn. 45

s=1, . . . , m, complemented by the algebraic equations:

$$\hat{C} \cdot [ \begin{matrix}{\overline{u}}_{1} \\ ⋮ \\ {\overline{u}}_{m}\end{matrix} ] = {\overline{g}}_{N} . \qquad Eqn . 46$$

Eqn. 46 represents the continuity conditions for the normal fluxes on the interfaces between neighboring macro-cells in Ω_{H} and the Neumann boundary condition on Γ_{N}. In these equations, \hat{M}ₛ is a square \hat{n}_{u,s}×\hat{n}_{u,s} symmetric positive definite matrix (the mass matrix in the space of fluxes), \hat{B}ₛ is a rectangular \hat{n}_{p,s}×\hat{n}_{p,s} matrix, Ĉₛ^{T} is a rectangular \hat{n}_{u,s}×\hat{n}_{λ,s} matrix, Σₛ is a diagonal \hat{n}_{p,s}×\hat{n}_{p,s} matrix wherein \hat{n}_{u,s}=dim \hat{V}_{H,s}, \hat{n}_{p,s}=dim Q_{H,s}, s=1, . . . , m, and \hat{n}_{λ}=dim \hat{Λ}_{H}. Since, by definition Q_{H}=Qₕ and, in particular, Q_{H,s}=Q_{h,s}, S=1, . . . , m, \hat{n}_{p,s}=n_{p,s}, the matrix Σₛ in Eqn. 45 coincides with matrix Σₛ in Eqn. 29, s=1, . . . , m.

The system in Eqns. 45 and 46 can be presented in a compact form by:

$$( \begin{matrix}\hat{M} & {\hat{B}}^{T} & {\hat{C}}^{T} \\ \hat{B} & - Σ & 0 \\ \hat{C} & 0 & 0\end{matrix} ) ( \begin{matrix}\overline{u} \\ \overline{p} \\ \overline{λ}\end{matrix} ) = ( \begin{matrix}{\overline{g}}_{D} \\ \overline{f} \\ {\overline{g}}_{N}\end{matrix} ) , \qquad Eqn . 47$$

wherein \hat{M}=\hat{M}₁⊕\hat{M}₂⊕ . . . ⊕\hat{M}ₘ and \hat{B}=\hat{B}₁⊕\hat{B}₂⊕ ⊕\hat{B}ₘ are m×m block diagonal matrices,

$$\hat{C} = ( {\hat{C}}_{1} … {\hat{C}}_{m} ) , \overline{u} = ( \begin{matrix}{\overline{u}}_{1} \\ ⋮ \\ {\overline{u}}_{m}\end{matrix} ) , \overline{p} = ( \begin{matrix}{\overline{p}}_{1} \\ ⋮ \\ {\overline{p}}_{m}\end{matrix} ) , \\ and \overline{λ} ∈ {R}^{{\hat{n}}_{λ}} .$$

Under the definitions presented herein, it can be shown that:

\hat{M}ₛ=Rₛ^{T}MₛRₛ \hat{B}ₛ=BₛRₛ

Ĉₛ^{T}=Rₛ^{T}Cₛ^{T}R_{λ} Eqn. 48

s=1, . . . , m. Thus, the resulting global matrices may be represented by:

\hat{M}=R^{T}MR

\hat{B}=BR

βĈ=R_{λ}^{T}CR Eqn. 49

### Homogenized Discretization on Ω_{H}

An equivalent algebraic system can be derived for discretization of Eqns. 42-44 with the coarse finite element spaces defined previously. Using this definition, it is possible to reinterpret the definition of the degrees of freedom associated with the Lagrange multipliers. This can be performed by considering a macro-cell Eₛ, s=1, . . . , m, in Ω_{H} and selecting a basis vector-function ŵₕ in \hat{V}ₕ(Eₛ). Then the finite element equation shown in Eqn. 26, which corresponds to this basis function, can be given by:

$${\int }_{{E}_{s}} ( {K}^{- 1} {\hat{u}}_{h} ) \cdot {\hat{w}}_{h} d x - {\int }_{{E}_{s}} {\hat{p}}_{h} ( ∇ \cdot {\hat{w}}_{h} ) d x + {\int }_{{Γ}_{s}} {λ}_{h} ( {\hat{w}}_{h} \cdot {n}_{s} ) d s = - {\int }_{{Γ}_{D , s}} {g}_{D} ( {\hat{w}}_{h} \cdot {n}_{s} ) d s . \qquad Eqn . 50$$

If the basis vector function ŵₕ belongs to the space associated with the interior degrees of freedom for the normal fluxes or with the external boundary wherein a Dirichlet boundary condition is imposed then the third term of Eqn. 50 drops out.

A face F≡F_{s,j}, j=1, . . . , rₛ, of a macro-cell Eₛ belonging to Γₛ can be selected, and ŵₕ can be selected to be one of the basis vector-functions {ŵ_{j,i}} of Ŵ_{h,s,j} with the assumption that its face-averaged value over F is non-negative, in other words,

$${d}_{w} = {\int }_{F} {\hat{w}}_{h} \cdot {n}_{s} d s > 0.$$

Accordingly, the finite element equation provided in Eqn. 50, which may correspond to this basis function, can be written in an equivalent form:

$${\int }_{{E}_{s}} ( {K}^{- 1} {\hat{u}}_{h} ) \cdot {\hat{w}}_{h} d x - {\int }_{{E}_{s}} {\hat{p}}_{h} ( ∇ \cdot {\hat{w}}_{h} ) d x + {d}_{w} \cdot {λ}_{w} = 0 , \qquad Eqn . 51$$

wherein:

$${λ}_{w} = \frac{1}{{d}_{w}} {\int }_{F} {λ}_{h} ( {\hat{w}}_{h} \cdot {n}_{s} ) d s . \qquad Eqn . 52$$

In this form, λ_{w} can be interpreted as the new degree of freedom for the Lagrange multipliers λₕ associated with the specifically selected basis vector-function ŵₕεŴ_{h,F}. If it is assumed that the basis vector-functions {ŵ_{j,i}}εŴ_{h,s,j} in Eqn. 34 satisfy the condition:

$${d}_{j , i} = {\int }_{\partial {E}_{s}} {\hat{w}}_{j , i} \cdot {n}_{s} d s > 0 , j = 1 , … , {r}_{s} ,$$

then, for a given macro-cell Eₛ, the first group of equations in Eqn. 45 can be written as

\hat{M}ₛūₛ+\hat{B}ₛ^{T}\hat{p}ₛ+Ĉₛ^{T} λ̅= g̅_{D,s}, Eqn, 53

with the same vector g̅_{D,s}, but with different matrix Ĉₛ^{T} and different vector λ̅ due to different interpretation of the degrees of freedom for the Lagrange multipliers. The components of the flux vector ūₛ can be partitioned into its components belonging to the boundary ∂Eₛ of Eₛ (denoted by index “F”) and its components associated with the interior degrees of freedom with respect to Eₛ (denoted by index “I”). Then Eqn. 53 can be presented in 2×2 block form:

$$( \begin{matrix}{\hat{M}}_{s , F} & {\hat{M}}_{s , FI} \\ {\hat{M}}_{s , IF} & {\hat{M}}_{s , I}\end{matrix} ) ( \begin{matrix}{\overline{u}}_{s , F} \\ {\overline{u}}_{s , I}\end{matrix} ) + ( \begin{matrix}{\hat{B}}_{s , F}^{T} \\ {\hat{B}}_{s , I}^{T}\end{matrix} ) {\overline{p}}_{s} + ( \begin{matrix}{\hat{C}}_{s , F}^{T} \\ 0\end{matrix} ) \overline{λ} = ( \begin{matrix}{\overline{g}}_{D , {Γ}_{s}} \\ 0\end{matrix} ) , \qquad Eqn . 54$$

wherein g̅_{D,Γ}_{ₛ} is the subvector of g̅_{D,s}, corresponding to the faces on Γₛ.

A simple example to describe the matrix Ĉ_{s,F}^{T} in Eqn. 54 can be considered in which the domain Q consists of two macro-cells E₁ and E₂, with the interface F and boundary ∂Ω≡Γ_{D}. In this case, the nonzero blocks of Ĉ_{1,F}^{T} and Ĉ_{2,F}^{T} are equal to the same diagonal t×t matrix D_{F} with the diagonal entries:

$${d}_{F , i} = {\int }_{F} {\hat{w}}_{1 , i} \cdot {n}_{1} d s ,$$

wherein ŵ_{1,i} are the basis vector-functions on E₁ associated with F, i=1, . . . , t, n₁ is the unit normal to F outward with respect to E₁, and t is the total number of the basis vector-functions on E₁. Thus, in this example, the matrix Ĉs,F^{T} in Eqn. 54 may be represented as: (Ĉ_{1,F}^{T} λ̅)_{F}=(Ĉ_{2,F}^{T} λ̅)_{F}=D_{F} λ̅.

The matrix Q_{F} may be introduced, wherein Q_{F} has the entries:

$${q}_{F , ij} = {\int }_{F} ( {\hat{w}}_{1 , i} \cdot {n}_{1} ) ( {\hat{w}}_{1 , j} \cdot {n}_{1} ) d s , i , j = 1 , … , t .$$

Using the interpretation of the degrees of freedom shown in Eqn. 52 for the Lagrange multipliers it is possible to connect the vector λ̅= λ̅_{new} in Eqn. 54 with the vector λ̅= λ̅_{old} in Eqn. 47 by the transformation:

λ̅_{new}=D_{F}⁻¹Q_{F} λ̅_{old}. Eqn. 55

The transformation shown in Eqn. 55 can be extended to the mesh Ω_{H}, with a diagonal matrix D_{λ}, and a block diagonal matrix Q_{λ}, with one diagonal block per interface between neighboring macro-cells in Ω_{H} or per a face of a macro-cell in Ω_{H} belonging to Γ_{N}. It may be noted that on the coarse computational mesh Ω_{H} the finite element subspaces satisfy similar constraints as those for the finest computational mesh Ωₕ. In particular, element vector functions have constant normal components on the interfaces between two neighboring macro-cells as well as the intersections of the boundary of the macro-cell with the Neumann part of the boundary (macro Neumann faces). Since each macro-face is formed by an assembly of computational faces on a finer mesh, the dimension of the finite element subspaces, which is equal to the total number of interfaces and Neumann faces, decreases as one progresses in the hierarchical structure (from finer to coarser meshes).

Using the definition of degrees of freedom for the Lagrange multipliers λ presented in Eqn. 52, and the new partition of the flux function introduced in Eqn. 54, the system of Eqns. 45 and 46 for each macro-cell Eₛ in Ω_{H} can be presented in the following algebraic form:

\hat{M}_{s,F}ū_{s,f}+\hat{M}_{s,FI}ū_{s,I}+\hat{B}_{s,f}^{T} p̅ₛ+Ĉ_{s,f}^{T} λ̅= g̅_{D,Γ}_{ₛ}

\hat{M}_{s,IF}ū_{s,f}+\hat{M}_{s,I}ū_{s,I}+\hat{B}_{s,I}^{T}pₛ=0

\hat{B}_{s,F}ū_{s,F}+\hat{B}_{s,I}ū_{s,I}−Σₛpₛ=fₛ Eqn. 56

s=1, . . . , m, complemented by the equations:

Ĉū= g̅_{N}, Eqn. 57

for the continuity of normal fluxes on the interfaces between macro-cells on Ω_{H} and for the Neumann boundary condition on Γ_{N}. It should be noted that the segregation between interior and boundary faces is a significant aspect of the method presented below.

The homogenization algorithm used in exemplary embodiments of the present techniques consists of two major steps. At the first step, the subvectors u_{s,I} and p̅ₛ may be eliminated in the system described by Eqn. 56, assuming that the matrices

$$( \begin{matrix}{\hat{M}}_{s , I} & {\hat{B}}_{s , I}^{T} \\ {\hat{B}}_{s , I} & - {\sum }_{s}\end{matrix} )$$

are nonsingular. For example, these matrices are nonsingular if the coefficient c in Eqn. 18 is not equal to zero in Eₛ, s=1, . . . , m.

After the elimination step the following algebraic system results:

\tilde{M}_{s,F}ū_{s,F}+Ĉ_{s,F}^{T} λ̅= ξ̅_{D,s}, s=1, . . . ,m, Eqn. 58

which is complemented by Eqns. 57.

At the second step, a new degree of freedom may be introduced. This degree of freedom is the value of the primary variable p_{H,s}, restricted to the macro-cell Eₛ. Accordingly, the system represented in Eqns. 57 and 58 may be replaced by the system:

M_{H,s}ū_{H,s}+B_{H,s}^{T} p̅_{H,s}+Ĉ_{H,s}^{T} λ̅_{H}= g̅_{D,H,s},

B_{H,s}ū_{H,s}−Σ_{H,s} p̅_{H,s}= f̅_{H,s} Eqn. 59

wherein s=1, . . . , m. This is complemented by the equation:

Cₕū_{H}= g̅_{N,H}, Eqn. 60

wherein ū_{H}^{T}=(ū_{H,1}^{T} . . . ū_{H,m}^{T}) and C_{H}=(C_{H,1} . . . C_{H,m}).

The matrices B_{H,s} and Σ_{H,s} and the value f_{H,s} in Eqn. 59 can be derived by integrating the conservation law equation, ∇·u+c·p=f, in Eqn. 18 over the macro-cell Eₛ on Ω_{H}, s=1, . . . , m. Let Γₛ be the part of the boundary of Eₛ belonging to Ω∪Γ_{N} and {w_{s,1}, . . . , w_{s,qs}} be the set of all basis vector-functions in V_{H,s} associated with ∂Eₛ, s=1, . . . , m. Then the finite element conservation law on Eₛ is obtained in the form of the following algebraic equation:

$${\sum }_{i = 1}^{{q}_{s}} {γ}_{s , i} {u}_{H , s , i} + {\sum }_{H , s} {p}_{H , s} = - {f}_{H , s} ,$$

wherein:

$${γ}_{s , i} = {\int }_{\partial {E}_{s}} {w}_{s , i} \cdot {n}_{s} d s , i = 1 , … , {q}_{s}$$

$${Σ}_{H , s} = {\int }_{{E}_{s}} c d x = \vert {E}_{s} \vert \cdot \overline{c}$$

$${u}_{H , s , i} = {γ}_{s , i}^{- 1} {\int }_{\partial {E}_{s}} u \cdot {n}_{s} d s , i = 1 , … , {q}_{s} , \\ {p}_{H , s} = {Σ}_{H , s}^{- 1} {\int }_{{E}_{s}} c \cdot p d x$$

$${f}_{H , s} = - {\int }_{{E}_{s}} f d x = - \vert {E}_{s} \vert \cdot \overline{f}$$

and s=1, . . . , m. In these equations, γ_{s,i} is the area of the i-th boundary face, |Eₛ| is the volume of the macro-cell and an over-bar denotes a volume average over the cell Eₛ. Further, u_{H,s,i}, i=1, . . . , qₛ, and p_{H,s} represent the new degrees of freedom for the flux vector-functions and the homogenized degree of freedom for the solution function in Eₛ. Accordingly, the matrices B_{H,s}, M_{H,s}, and the vector g̅_{D,H,s}, in Eqn. 59 can be defined by:

$$\begin{matrix}{B}_{H , s} = - ( {γ}_{s , 1} … {γ}_{s , {q}_{s}} ) ∈ {R}^{1 \times {q}_{s}} , & Eqn . 61 \\ {M}_{H , s} = {\tilde{M}}_{s , F} - \frac{1}{{Σ}_{H , s}} {B}_{H , s}^{T} {B}_{H , s} , and & Eqn . 62 \\ {\overline{g}}_{D , H , s} = {\overline{ξ}}_{D , s} - \frac{1}{{Σ}_{H , s}} {B}_{H , s}^{T} {f}_{H , s} , & Eqn . 63\end{matrix}$$

respectively. Under the conditions presented in Eqns. 61-63, the equations in Eqn. 58 are equivalent to the equations shown in Eqn. 59 and can be obtained by elimination of P_{H,s}, s=1, . . . , m, from Eqn. 59. The system represented by Eqns. 59 and 60 can be called the homogenized discretization for Eqns. 18 and 19 on coarse mesh Ω_{H} with the finite element spaces V_{H}, Q_{H}, and Λ_{H}.

### Coarsening Algorithms for Normal Components of Flux Vector Functions

If E is a macro-cell in Ω_{H}, then, without loss of generality, it can be assumed that E has nonzero intersections with the subdomains (or geologic layers as discussed with respect to FIGS. 8 and 9) Ω₁, Ω₂, . . . , Ωₜ, wherein t is a positive integer, 1≦t≦N_{z}. To describe the coarsening algorithms, three major assumptions may be imposed. First, the boundaries of pinch-outs belong to the union of lateral edges of macro-cells E in Ω_{H}. Second, the intersections of Ē with the boundaries of Ωₗ, l=1, . . . , t, are planar. Third, the diffusion tensor K is constant in each Ωₗ, i.e. K≡Kₗ in E∩Ωₗ, l=1, . . . , t.

From these assumptions, it follows that lateral faces of E are triangles and belong either to the interior of Ω₁ and Ωₜ, or to the boundaries of these subdomains. To this end, it can be assumed that the normal components of the finite element vector functions in V_{H}(E) are constants on the top and bottom lateral faces of E. This can be the first step of the coarsening algorithm.

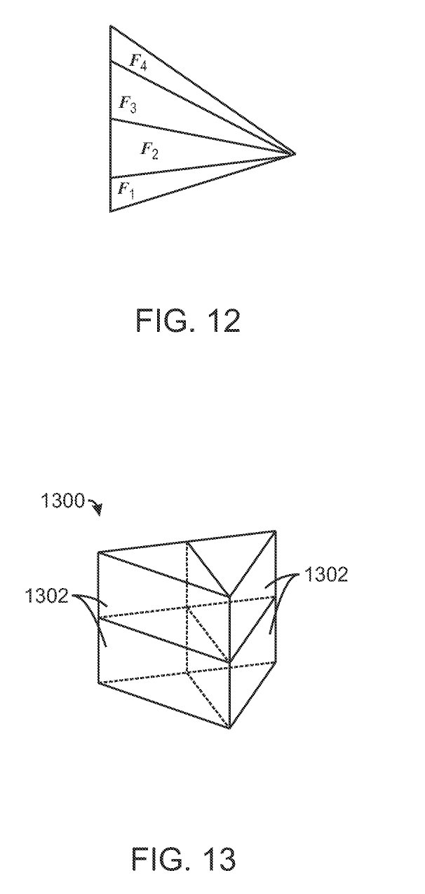

If F is vertical face of E, and Fᵢ denotes the intersections of F with the subdomains 902 Ωₗ, l=1, . . . , t, then the face F is a union of quadrilaterals and triangles (if any), for example, as shown in FIGS. 11 and 12.

FIGS. 11A and 11B are illustrations showing the partitioning of a vertical quadrilateral face into subfaces, in accordance with an exemplary embodiment of the present techniques. The vertical quadrilateral face is generally referred to as F 1100. In FIG. 11A, F 1100 is partitioned into subfaces Fₗ 1102, l=1, . . . , 4. In FIG. 11B, F 1100 is partitioned into subfaces Fₗ 1104, l=1, . . . ,5. FIG. 12 is an illustration showing the partitioning of a vertical triangular face F into subfaces Fₗ, l=1, . . . ,4, in accordance with an exemplary embodiment of the present techniques. The intersections of E with Ωₗ, l=1, . . . , t, can be denote by Fₗ. Further, the boundaries/interfaces between Eₗ₋₁ and Eₗ, l=2, . . . , t can be denoted by Γ_{l-1,l}.

In the second step of the coarsening algorithm, the condition that the normal components of the finite element flux vector functions are constant can be imposed on each subface Fₗ, l=1, . . . , t. For this step the matrix Rⱼ=R_{F}, for example, as shown in Eqn. 37, is a t×t block diagonal matrix wherein the diagonal blocks are column vectors with all components equal to one. The resulting space of finite element flux vector functions has constant normal components on each subface Fₗ, l=1, . . . , t. These components can be denoted by ξₗ, l=1, . . . , t.

In the third coarsening step, a piece-wise constant vector field νₗ=(ν_{l,1}, ν_{l,2}, ν_{l,3})^{T} can be introduced in each Eₗ, l=1, . . . , t, subject to the following conditions:

2. νₗ·n_{E}=ξₗ on Fₗ, l=1, . . . ,t,

3. (νₗ₋₁−νₗ)·n_{l-1,l}=0 on Γ_{l-1,l}, l=2, . . . ,t, Eqn. 64

wherein n_{l-1,l} is the unit normal on Γ_{l-1,l} directed from Eₗ₋₁ to Eₗ, l=2, . . . , t. Another condition can be imposed on the above piece-wise constant vector functions ν. Specifically, it can be assumed that a piece-wise smooth continuous function ψ=ψ(x) exists such that:

ν=−K·∇ψ in E.

The above assumption implies the following set of constraints for the function ν:

[K⁻¹(νₗ₋₁−νₗ)]×n_{l-1,l}=0 on Γ_{l-1,l}, l=2, . . . ,t, Eqn. 65

in other words, it is assumed that the tangential components of the vector-function K⁻¹ν are continuous on Γ_{l-1,l}, l=2, . . . , t.

The conditions can be combined in the algebraic system:

N ν̅= ξ̅, Eqn. 66

wherein N is an n_{ξ}×n_{ν} matrix, the vector ν̅ is of dimension n_{ν}3t with the components ν_{l,1}, ν_{l,2}, ν_{l,3}, l=1, . . . , t, and the vector ξ̅ is of dimension n_{ξ}=3(t−1)+t=4t−3 with t components equal to ξₗ, l=1, . . . , t, and no other 3(t−1) components.

It can be noted that if one of the vectors vₗ, l=1, . . . , t, is known or specified (for instance, vector ν₁) then all other vectors (i.e. vectors ν₂, ν₃, . . . , νₜ) can be uniquely defined using the condition 2 shown in Eqn. 64 and the conditions presented in Eqn. 65. It may follow that the rank of the matrix N cannot be larger than 3.

Accordingly, a condition for the system in Eqn. 66 to be consistent is that any t−3 values of ξₗ, l=1, . . . , t, should be presented as a linear combination of three other values with coefficients independent of the values ξₗ, l=1, . . . , t. Algebraic formulae for coarsening of the set ξₗ, l=1, . . . , t, for t>0 can be derived explicitly assuming that the rank of the matrix N in Eqn. 66 is equal to 3.

### Coarsening Algorithms for Specific Cases

Coarsening algorithms for two specific cases are discussed below. Without loss of generality, it can be assumed that the face F is orthogonal to the coordinate axis x₁.

For the first case, it can be assumed that the interface boundaries Γ_{l-1,l}, l=2, . . . , t, are parallel to the coordinate plane (x₁, X₂) and the diffusion matrices are defined by

$${K}_{l} = ( \begin{matrix}{k}_{l , 1} & 0 & 0 \\ 0 & {k}_{l , 22} & {k}_{l , 23} \\ 0 & {k}_{l , 32} & {k}_{l , 33}\end{matrix} ) , l = 1 , … , t .$$

Algebraic analysis can be used to show that, in this case, the normal components ξₗ on F of the vector function ν are connected by the following relations

k_{l-1,1}ξₗ₋₁=k_{l,1}ξₗ, l=2, . . . ,t

If ξ₁ is chosen to be an independent variable then the other t−1 components are defined by recurrent formulas

$$\frac{{ξ}_{l}}{{ξ}_{l - 1}} = \frac{{k}_{l - 1 , 1}}{{k}_{l , 1}} , l = 2 , … , t ,$$

and the corresponding transformation matrix R_{F} is the vector column in R^{t} is equal to R_{F}=(1, k_{1,1}k_{2,1}⁻¹,k_{2,1}k_{3,1}⁻¹, . . . , k_{t-1,1}k_{t,1}⁻¹)^{T}.

The second important case can be based on an assumption that the interface boundaries Γ_{l-1,l}, l=2, . . . , t, are mutually parallel and orthogonal to the vertical edges of F and the diffusion matrices have special structure with respect to the interfaces Γ_{l-1,l}, l=2, . . . , t. For example, for a piece-wise constant scalar diffusion tensor the rank of the matrix N in Eqn. 66 is equal to 2.

### Multilevel Approach

In the previous sections the homogenization algorithm was described only for the case of two meshes: fine mesh Ωₕ and coarse mesh Ω_{H}. The method also can be extended to a hierarchical sequence of meshes

Ω_{h,0},Ω_{h,1}, . . . , Ω_{h,L},

wherein L≧1 is an integer, Ωₕ=Q_{h,0} is the fine mesh, Ω_{H}=Q_{h,L} is the coarse mesh. The mesh Q_{h,l} is obtained from the mesh Q_{h,l-1}, l=1, . . . , L, by an application of the coarsening algorithm described above. As described, the coarsening algorithms can be arbitrary. For example, in one particular case, each “coarse” prism EεΩ_{h,l} consists of eight “fine” prisms eεΩ_{h,l-1}, l=1, . . . , L, as shown in FIG. 10, while in another example of coarsening each “coarse” prism EεΩ_{h,l} may consist of four “fine” prisms eεΩ_{h,l-1}, l=1, . . . , L, as shown in FIG. 13.

FIG. 13 is a schematic illustrating the division of a coarse prism 1300 into four fine prisms 1302, in accordance with an embodiment of the present techniques.

A multilevel approach may provide some further advantages to the techniques presented herein. Specifically, if the coarsening algorithm described in the previous sections is applied directly to the meshes Ωₕ=Ω_{h,0} and Ω_{H}=Ω_{h,L}, large size matrices are inverted. For example, if there are no pinch-outs, then each mesh cell EεΩ_{H} consists of 4^{L} mesh cells eεΩₕ. In order to do an algebraic coarsening in E a matrix of the size equal to the number of interfaces between mesh cells e in E must be inverted. This number is of the order O(4^{L}). For instance, if L=3, matrices that are larger than about 64 (i.e., 4³) are inverted.

In order to reduce the computational load, a two-level approach can be substituted with a multilevel approach. In the multilevel approach, a fine mesh system can be constructed on a mesh Ωₕ=Q_{h,0}, then denote Ω_{H}=Ω_{h,1}, and apply the algorithm to obtain a coarse system on Ω_{H}. Thus, no matrices larger than size four are inverted. The coarsening procedure may then be repeated on mesh Ω_{h,1}. In this case, Ωₕ=Q_{h,1} can be defined to be a new fine mesh and Ω_{H}=Q_{h,2} as the new coarse mesh. By applying the same algorithm L times, ultimately the system is transferred to the new coarse mesh Ω_{H}=Q_{h,L}. The coarsening algorithm is described in further detail below.

The initialization of the coarsening algorithm can be performed by considering Ωₕ=Q_{h,0} to be the fine mesh. A hybrid mixed formulation may then be applied (in other words, Lagrange multipliers may be introduced on all interfaces between cells of the fine mesh as well as on the Neumann part of the boundary Γ_{N}). This results in an algebraic system of the form:

$$( \begin{matrix}{M}_{0} & {B}_{0}^{T} & {C}_{0}^{T} \\ {B}_{0} & - {\sum }_{0} & 0 \\ {C}_{0} & 0 & 0\end{matrix} ) ( \begin{matrix}{u}_{0} \\ {p}_{0} \\ {λ}_{0}\end{matrix} ) = ( \begin{matrix}{F}_{u , 0} \\ {F}_{p , 0} \\ {F}_{λ , 0}\end{matrix} ) .$$

Here, the subindex 0 indicates that all matrices are defined on mesh Q_{h,0}. Then, p₀ is excluded, by inverting the diagonal matrix Σ₀, to obtain a system in terms of (u₀, λ₀):

$$( \begin{matrix}{A}_{0} & {C}_{0}^{T} \\ {C}_{0} & 0\end{matrix} ) ( \begin{matrix}{u}_{0} \\ {λ}_{0}\end{matrix} ) = ( \begin{matrix}{\hat{F}}_{u , 0} \\ {F}_{λ , 0}\end{matrix} ) ,$$

wherein A₀=M₀+B_{O}^{T}Σ⁻¹B₀ and \hat{F}_{u,0}=F_{u,0}+B_{O}^{T}Σ⁻¹F_{p,0}. It can be noted that the mass matrix M₀ is a block diagonal matrix. Therefore, the matrix A₀ is also block diagonal and can be evaluated cell-by-cell.

After initialization, the algebraic coarsening may be performed. This can be done by letting l, l=1, . . . , L, be an integer, and assuming that the algebraic system can be constructed on a new fine mesh Ωₕ=Ω_{h,l-1} of the form:

$$( \begin{matrix}{A}_{l - 1} & {C}_{l - 1}^{T} \\ {C}_{l - 1} & 0\end{matrix} ) ( \begin{matrix}{u}_{l - 1} \\ {λ}_{l - 1}\end{matrix} ) = ( \begin{matrix}{\hat{F}}_{u , l - 1} \\ {F}_{λ , l - 1}\end{matrix} ) .$$

Indeed, that system can be constructed for l=1, for other numbers l=2, . . . L, the following procedure can be applied recursively. The degrees of freedom uₗ₋₁ and λₗ₋₁ can be divided into two groups:

$${u}_{l - 1} = ( \begin{matrix}{u}_{l - 1 , Γ} \\ {u}_{l - 1 , i}\end{matrix} ) , and {λ}_{l - 1} = ( \begin{matrix}{λ}_{l , 1 , Γ} \\ {λ}_{l - 1 , i}\end{matrix} ) ,$$

wherein the second group (subvectors u_{l-l,i} and λ_{l-1,i}) incorporate the degrees of freedom corresponding to the faces of Ω_{h,l-1}, which are internal with respect to cells in the Ω_{h,l}. The rest of degrees of freedom can be incorporated into the first group. Then, the following two steps can be followed to coarsen the mesh. In the first step, the internal degrees of freedom u_{l-1,i} and λ_{l-1,I} are eliminated. In the second step, the transformation of the degrees of freedom u_{l=R}^{T}u_{l-1,Γ} and λᵢ=R_{λ}^{T}λ_{l-1,Γ} can be performed. As a result, the system:

$$( \begin{matrix}{A}_{l} & {C}_{l}^{T} \\ {C}_{l} & 0\end{matrix} ) ( \begin{matrix}{u}_{l} \\ {λ}_{l}\end{matrix} ) = ( \begin{matrix}{\hat{F}}_{u , l} \\ {F}_{λ , l}\end{matrix} )$$

is obtained in terms of (uₗ, λₗ) on the new coarse mesh Ω_{H}=Ω_{h,l}. It should be noted that the mass matrix Mₗ can be computed cell by cell (with respect to Ω_{h,l}) by:

Mₗ=Aₗ−Bₗ^{T}Σₗ⁻¹Bₗ

wherein the matrix Σₗ is diagonal.

After coarsening, the term p_{L} can be introduced. After repeating the coarsening procedure L times, the algebraic system:

$$( \begin{matrix}{A}_{L} & {C}_{L}^{T} \\ {C}_{L} & 0\end{matrix} ) ( \begin{matrix}{u}_{L} \\ {λ}_{L}\end{matrix} ) = ( \begin{matrix}{\hat{F}}_{u , L} \\ {F}_{λ , L}\end{matrix} ) ,$$

is obtained in terms of the (u_{L}, λ_{L}) associated with the most coarse mesh Ω_{H}=Ω_{h,L}. The vector p_{L} may be introduced to obtain the same macro-hybrid mixed system:

$$( \begin{matrix}{M}_{L} & {B}_{L}^{T} & {C}_{L}^{T} \\ {B}_{L} & - {Σ}_{L} & 0 \\ {C}_{L} & 0 & 0\end{matrix} ) ( \begin{matrix}{u}_{L} \\ {p}_{L} \\ {λ}_{L}\end{matrix} ) = ( \begin{matrix}{F}_{u , L} \\ {F}_{p , L} \\ {F}_{λ , L}\end{matrix} ) .$$

In order to solve the system above, a block diagonal matrix M_{L} is inverted (although most of the blocks have the size 5, pinch-outs may result in blocks of size 4). The subvector u_{L} is then eliminated. As a result, the symmetric positive system is obtained on the coarse mesh in the form

$$( \begin{matrix}{S}_{p} & {S}_{p λ} \\ {S}_{λ p} & {S}_{λ}\end{matrix} ) ( \begin{matrix}{p}_{L} \\ {λ}_{L}\end{matrix} ) = ( \begin{matrix}{G}_{p , L} \\ {G}_{λ , L}\end{matrix} ) .$$

This system is solved to obtain the solution pair (p_{L}, λ_{L}). Then, the vector of degrees of freedom for fluxes is reconstructed by

M_{L}u_{L}=F_{u,L}−B_{L}^{T}p_{L}−C_{L}^{T}λ_{L}.

Finally, the solution may be recovered on the fine mesh Ωₕ=Ω_{h,0}. At this step, it can be assumed that the solution triple (uₗ, pₗ, λₗ) is known for some l, l=1, . . . , L. Then, the algebraic coarsening procedure can be reverted to obtain the solution triple (uₗ₋₁, pₗ₋₁, λₗ₋₁) on mesh Ω_{h,l-1}. This procedure can be repeated L times to obtain the desired solution triple (u₀, p₀, λ₀) associated with the finest mesh Ωₕ=Ω_{h,0}.

### Systems

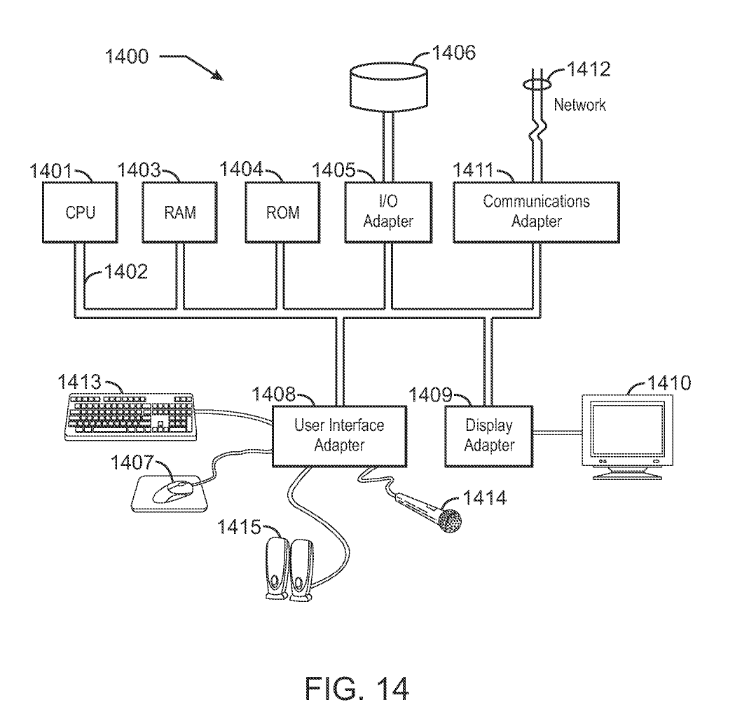

The techniques discussed herein may be implemented on a computing device, such as that illustrated in FIG. 14. FIG. 14 illustrates an exemplary computer system 1400 on which software for performing processing operations of embodiments of the present techniques may be implemented. A central processing unit (CPU) 1401 is coupled to a system bus 1402. In embodiments, the CPU 1401 may be any general-purpose CPU. The present techniques are not restricted by the architecture of CPU 1401 (or other components of exemplary system 1400) as long as the CPU 1401 (and other components of system 1400) supports the inventive operations as described herein. The CPU 1401 may execute the various logical instructions according to embodiments. For example, the CPU 1401 may execute machine-level instructions for performing processing according to the exemplary operational flow described above in conjunction with FIG. 1. As a specific example, the CPU 1401 may execute machine-level instructions for performing the method of FIG. 1.

The computer system 1400 may also include random access memory (RAM) 1403, which may be SRAM, DRAM, SDRAM, or the like. The computer system 1400 may include read-only memory (ROM) 1404 which may be PROM, EPROM, EEPROM, or the like. The RAM 1403 and the ROM 1404 hold user and system data and programs, as is well known in the art. The programs may include code stored on the RAM 1404 that may be used for modeling geologic properties with homogenized mixed finite elements, in accordance with embodiments of the present techniques.

The computer system 1400 may also include an input/output (I/O) adapter 1405, a communications adapter 1414, a user interface adapter 1408, and a display adapter 1409. The I/O adapter 1405, user interface adapter 1408, and/or communications adapter 1411 may, in certain embodiments, enable a user to interact with computer system 1400 in order to input information.

The I/O adapter 1405 may connect the bus 1402 to storage device(s) 1406, such as one or more of hard drive, compact disc (CD) drive, floppy disk drive, tape drive, flash drives, USB connected storage, etc. to computer system 1400. The storage devices may be utilized when RAM 1403 is insufficient for the memory requirements associated with storing data for operations of embodiments of the present techniques. For example, the storage device 1406 of computer system 1400 may be used for storing such information as computational meshes, intermediate results and combined data sets, and/or other data used or generated in accordance with embodiments of the present techniques.

The communications adapter 1411 is adapted to couple the computer system 1400 to a network 1412, which may enable information to be input to and/or output from the system 1400 via the network 1412, for example, the Internet or other wide-area network, a local-area network, a public or private switched telephony network, a wireless network, or any combination of the foregoing. The user interface adapter 1408 couples user input devices, such as a keyboard 1413, a pointing device 1407, and a microphone 1414 and/or output devices, such as speaker(s) 1415 to computer system 1400. The display adapter 1409 is driven by the CPU 1401 to control the display on the display device 1410, for example, to display information pertaining to a target area under analysis, such as displaying a generated representation of the computational mesh, the reservoir, or the target area, according to certain embodiments.

It shall be appreciated that the present techniques are not limited to the architecture of the computer system 1400 illustrated in FIG. 14. For example, any suitable processor-based device may be utilized for implementing all or a portion of embodiments of the present techniques, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

While the present techniques may be susceptible to various modifications and alternative forms, the exemplary embodiments discussed above have been shown only by way of example. However, it should again be understood that the present techniques are not intended to be limited to the particular embodiments disclosed herein. Indeed, the present techniques include all alternatives, modifications, and equivalents falling within the true spirit and scope of the appended claims.

1. A method for using a processor to model geologic properties with homogenized mixed finite elements, comprising:
projecting features of a reservoir onto a horizontal plane to form a projection;
creating a two-dimensional unstructured computational mesh resolving desired features in the projection;
projecting the two-dimensional unstructured computational mesh onto boundary surfaces in order to define a finest computational mesh;
generating at least one coarser computational mesh, wherein the at least one coarser computational mesh comprises a plurality of computational cells, and each of the plurality of computational cells comprises a plurality of finer cells;
generating a plurality of computational faces associated with each of the plurality of computational cells, wherein each of the computational faces comprises a plurality of finer faces;
associating a first unknown with each of the plurality of computational cells and a second unknown with each of the plurality of computational faces;
deriving a macro-hybrid mixed finite element discretization on the finest computational mesh;
iterating through a coarsening procedure to transfer known information from the finest computational mesh to a coarsest computational mesh;
solving matrix equations to obtain values for each of the first unknowns for each of the plurality of computational cells in the coarsest computational mesh;
solving matrix equations to obtain values for each of the second unknowns for each of the plurality of computational faces in the coarsest computational mesh; and
iterating through a restoration procedure to restore the values of the primary unknowns to each of the plurality of finer cells and the secondary unknowns to each of the plurality of finer faces.

2. The method of claim 1, wherein projecting the features of the reservoir comprises projecting pinch-out boundaries, fault lines, or well locations into the horizontal plane.

3. The method of claim 2, wherein the projection is non-orthogonal and/or slanted.

4. The method of claim 1, wherein the two-dimensional unstructured computational mesh comprises squares, polygons, quadrilaterals, or triangles or any combinations thereof.

5. The method of claim 1, wherein the plurality of computational cells comprise boxes, hexagons, prisms, tetrahedra, pyramids, or any combinations thereof.

6. The method of claim 1, wherein the first unknown corresponds to a physical property of the reservoir.

7. The method of claim 1, wherein the second unknown corresponds to a normal component of a flux.

8. The method of claim 1, wherein the finest computational mesh approximates boundary surfaces of layers of interest.

9. The method of claim 8, wherein physical properties are defined on the finest computational mesh.

10. The method of claim 9, wherein the physical properties comprise fluid pressure, temperature, permeability, thermal conductivity or any combinations thereof.

11. The method of claim 1, comprising performing a homogenized mixed finite element procedure for solving diffusion equations on a computational mesh.

12. A system for modeling geologic properties using homogenized mixed finite elements, comprising:
a processor;
a storage medium comprising a database comprising reservoir data; and
a machine readable medium comprising code configured to direct a processor to:
project features of a reservoir onto a horizontal plane to form a projection;
create a two-dimensional unstructured computational mesh resolving desired features in the projection;
project the two-dimensional unstructured computational mesh onto boundary surfaces in order to define a finest computational mesh;
generate at least one coarser computational mesh, wherein the coarser computational mesh comprises a plurality of computational cells, and each of the plurality of computational cells comprises a plurality of finer cells;
generate a plurality of computational faces associated with each of the plurality of computational cells, wherein each of the computational faces comprises a plurality of finer faces;
associate a first unknown with each of the plurality of computational cells and a second unknown with each of the plurality of computational faces;
derive a macro-hybrid mixed finite element discretization on the finest computational mesh;
iterate through a coarsening procedure to transfer known information from the finest computational mesh to a coarsest computational mesh;
solve matrix equations to obtain values for each of the first unknowns for each of the plurality of computational cells in the coarsest computational mesh;
solve matrix equations to obtain values for each of the second unknowns for each of the plurality of computational faces in the coarsest computational mesh; and
iterate through a restoration procedure to restore the values of the primary unknowns to each of the plurality of finer cells and the secondary unknowns to each of the plurality of finer faces.

13. The system of claim 12, further comprising a display, wherein the machine readable media comprises code configured to generate an image of the reservoir on the display.

14. The system of claim 12, wherein the reservoir data comprises net-to-gross ratio, porosity, permeability, pressure, temperature, or any combinations thereof.

15. A method for hydrocarbon management of a reservoir, comprising:
generating a model of a reservoir comprising a plurality of homogenized mixed finite elements in an unstructured computational mesh;
coarsening the unstructured computational mesh to form a plurality of coarser computational meshes in the model;
evaluating a convection-diffusion subsurface process on a coarsest computational mesh;
transferring a result from the coarsest computational mesh to a finest computational mesh;
predicting a performance parameter for the hydrocarbon reservoir from the model; and
using the predicted performance parameter for hydrocarbon management of the reservoir.

16. The method of claim 15, further comprising:
projecting features of the reservoir onto a horizontal plane to form a projection;
creating a two-dimensional unstructured computational mesh resolving desired features in the projection;
projecting the two-dimensional unstructured computational mesh onto boundary surfaces in order to define the finest computational mesh;
generating a coarser computational mesh, wherein the coarser computational mesh comprises a plurality of computational cells, and each of the plurality of computational cells comprises a plurality of finer cells;
generating a plurality of computational faces associated with each of the plurality of computational cells, wherein each of the computational faces comprises a plurality of finer faces;
associating a first unknown with each of the plurality of computational cells and a second unknown with each of the plurality of computational faces;
deriving a macro-hybrid mixed finite element discretization on the finest computational mesh;
iterating through a coarsening procedure to transfer known information from the finest computational mesh to the coarsest computational mesh;
solving matrix equations to obtain values for each of the first unknowns for each of the plurality of computational cells in the coarsest computational mesh;
solving matrix equations to obtain values for each of the second unknowns for each of the plurality of computational faces in the coarsest computational mesh; and
iterating through a restoration procedure to restore the values of the primary unknowns to each of the plurality of finer cells and the secondary unknowns to each of the plurality of finer faces.

17. The system of claim 15, wherein the hydrocarbon management of the reservoir comprises hydrocarbon extraction, hydrocarbon production, hydrocarbon exploration, identifying potential hydrocarbon resources, identifying well locations, determining well injection rates, determining well extraction rates, identifying reservoir connectivity, or any combinations thereof.

18. The system of claim 15, wherein the performance parameter comprises a production rate, a pressure, a temperature, a permeability, a transmissibility, a porosity, a hydrocarbon composition, or any combinations thereof.

19. A tangible, computer readable medium comprising code configured to direct a processor to:
project features of a reservoir onto a horizontal plane to form a projection;
create a two-dimensional unstructured computational mesh resolving desired features in the projection;
project the two-dimensional unstructured computational mesh onto boundary surfaces in order to define a finest computational mesh that approximates the boundary surfaces;
generate at least one coarser computational mesh, wherein the coarser computational mesh comprises a plurality of computational cells, and each of the plurality of computational cells comprises a plurality of finer cells;
generate a plurality of computational faces associated with each of the plurality of computational cells, wherein each of the computational faces comprises a plurality of finer faces;
associate a first unknown with each of the plurality of computational cells and a second unknown with each of the plurality of computational faces;
derive a macro-hybrid mixed finite element discretization on the finest computational mesh;
iterate through a coarsening procedure to transfer known information from the finest computational mesh to a coarsest computational mesh;
solve matrix equations to obtain values for each of the first unknowns for each of the plurality of computational cells in the coarsest computational mesh;
solve matrix equations to obtain values for each of the second unknowns for each of the plurality of computational faces in the coarsest computational mesh; and
iterate through a restoration procedure to restore the values of the primary unknowns to each of the plurality of finer cells and the secondary unknowns to each of the plurality of finer faces.

20. The tangible, machine readable medium of claim 19, comprising code configured to direct the processor to display a representation of a reservoir.
